(19) United States
(12) Patent Application Publication
(10) Pub. No.: US 2019/0391507 A1
(43) Pub. Date: Dec. 26, 2019

(54) LIQUID DEVELOPER AND METHOD FOR PRODUCING PRINTED MATERIAL USING SAME

(71) Applicants: TOYO INK SC HOLDINGS CO., LTD., Tokyo (JP); TOYO INK CO., LTD., Tokyo (JP)

(72) Inventors: Yuji SONETA, Tokyo (JP); Kazumasa HATTORI, Tokyo (JP)

(73) Assignees: TOYO INK SC HOLDINGS CO., LTD., Tokyo (JP); TOYO INK CO., LTD., Tokyo (JP)

(21) Appl. No.: 16/078,007

(22) PCT Filed: Feb. 17, 2017
(86) PCT No.: PCT/JP2017/005927

§ 371 Date: Aug. 14, 2018

(30) Foreign Application Priority Data
Feb. 19, 2016 (JP) 2016-030156

(51) Int. Cl. G03G 9/13; G03G 9/135

(52) U.S. Cl. CPC G03G 9/131; G03G 9/135

(57) ABSTRACT

An embodiment of the present invention relates to a liquid developer which contains at least toner particles containing a binder resin (A) and a release agent (B), and a carrier liquid (C), wherein the toner particles also contain a compound represented by general formula (1) shown below:

R1-(O-A1)ₙ-OH General formula (1):

wherein n represents a natural number from 1 to 120, R1 represents a hydrocarbon group of 1 to 100 carbon atoms, and A1 represents an alkylene group of 2 to 4 carbon atoms.

### TECHNICAL FIELD

Embodiments of the present invention relate to a liquid developer and a method for producing the same, and a method for producing printed material.

### BACKGROUND ART

Liquid developers are dispersions containing micronized toner particles dispersed in a carrier liquid. In an electrophotographic method using a liquid developer, an electrostatic latent image formed on a photoreceptor by exposure is developed using the toner particles in the liquid developer and then transferred to a recording medium such as paper. Subsequently, an image is formed by performing steps including drying of the carrier liquid and fixation of the toner particles.

In one example of a liquid developer, fine grinding and dispersion of the toner particles are performed in a wet state, and therefore compared with a dry powder toner, finer micronization of the toner particles is possible. Further, because a carrier liquid composed of an insulating liquid is used as the carrier, problems caused by scattering of the toner particles inside the image forming device do not arise. As a result, a feature of image forming devices that use a liquid developer is the ability to form high-definition images.

In order to obtain high-quality images over a long period, the toner particles used in the liquid developer require favorable fixability, charge stability and dispersion stability within the carrier liquid (see Patent Literatures 1 and 2). In particular, dispersion stability within the carrier liquid is a property not required of dry developers, and therefore various investigations have already been conducted. For example, Patent Literature 3 describes an example in which an attempt is made to improve the dispersion stability by coating a portion of the toner particle surfaces with an ester-based wax (release agent) that has been plasticized with a fatty acid monoester, thereby preventing contact between toner particles. However, release agents and binder resins generally exhibit poor compatibility, meaning that often a phase separation into an islands-in-sea arrangement occurs within the toner particles, or that toner particles containing only one of the two components are obtained. Accordingly, effectively distributing a release agent within toner particles is actually difficult. Further, if an attempt is made to improve the dispersion stability of the toner particles, then the amount of heat required in the fixation process to achieve melting, contact and coalescence of the toner particles increases. As a result, various problems arise, including a deterioration in the fixability of the toner particles to the substrate, and the occurrence of the so-called cold offset phenomenon in which some of the incompletely melted toner particles adhere to the surface of the fixing roller and are subsequently transferred to the next sheet of paper.

In an attempt to address the above problems, Patent Literature 4 attempts to achieve a combination of the above properties by improving the polymeric dispersant that is used for dispersing the toner particles in the carrier liquid. However, the effects of the polymeric dispersant cause a deterioration in the charging characteristics of the toner, resulting in a deterioration in image density and a deterioration in the long-term stability of the image quality.

In this manner, conventional liquid developers still have considerable room for improvement in terms of achieving a combination of favorable dispersion stability within the carrier liquid, good fixability and cold offset resistance, while also obtaining excellent image density.

### CITATION LIST

### Patent Literature

Patent Literature 1: JP 05-333607 A
Patent Literature 2: JP 2007-505953 A
Patent Literature 3: JP 2009-015244 A
Patent Literature 4: JP 2009-145535 A

### SUMMARY OF INVENTION

### Technical Problem

Embodiments of the present invention have the objects of providing a liquid developer which has a combination of favorable dispersion stability within a carrier liquid, good fixability and cold offset resistance, and yields excellent image density, as well as providing a method for producing the liquid developer. Further, another embodiment of the present invention has an object of providing a method for producing printed material using the liquid developer.

### Solution to Problem

As a result of intensive investigation aimed at achieving the above objects, the inventors of the present invention discovered that the above objects could be achieved using the embodiments described below, and they were therefore able to complete the present invention.

In other words, one embodiment relates to a liquid developer which contains at least toner particles containing a binder resin (A) and a release agent (B), and a carrier liquid (C), wherein the toner particles also contain a compound represented by general formula (1) shown below.

R1-(O-A1)ₙ—OH General formula (1)

(In general formula (1), n represents a natural number from 1 to 120, R1 represents a hydrocarbon group of 1 to 100 carbon atoms, and A1 represents an alkylene group of 2 to 4 carbon atoms.)

In one embodiment, it is preferable that n in the general formula (1) is a natural number from 10 to 100.

Further, in one embodiment, it is preferable that A1 in the general formula (1) is an ethylene group.

Furthermore, in one embodiment, it is preferable that R1 in the general formula (1) is an aliphatic hydrocarbon group of 20 to 100 carbon atoms.

Further, in one embodiment, it is preferable that the HLB value of the compound represented by the general formula (1), measured using Griffin's method, is at least 10 but not more than 20.

Further, in one embodiment, it is preferable that the release agent (B) has a structure represented by R1 in the general formula (1).

Further, in one embodiment, it is preferable that the release agent (B) is a hydrocarbon-based wax.

Furthermore, in one embodiment, it is preferable that the binder resin (A) has a structure represented by general formula (2) shown below.

-(O-A2)ₘ- General formula (2):

(In general formula (2), m represents a natural number from 1 to 10, and A2 represents an alkylene group of 2 to 4 carbon atoms.)

Furthermore, another embodiment relates to a method for producing any one of the liquid developers described above, the method including a step of melt kneading a mixture containing the binder resin (A), the release agent (B), and the compound represented by the above general formula (1).

Moreover, yet another embodiment relates to a method for producing printed material, the method including a step of performing printing using any one of the liquid developers described above.

The disclosure of this application is related to the subject matter disclosed in prior Japanese Application 2016-30156 filed on Feb. 19, 2016, the entire contents of which are incorporated herein by reference.

### Advantageous Effects of Invention

Embodiments of the present invention are able to provide a liquid developer which has a combination of favorable dispersion stability within a carrier liquid, good fixability and cold offset resistance, and yields excellent image density, as well as providing a method for producing the liquid developer. Further, another embodiment of the present invention can provide a method for producing printed material using the liquid developer.

### DESCRIPTION OF EMBODIMENTS

Embodiments of the present invention are described below in detail. The embodiments described below describe examples of the present invention. The present invention is in no way limited by the following embodiments, and also includes modifications that can be made without altering the scope of the present invention.

### (Liquid Developer)

The liquid developer that represents an embodiment of the present invention contains at least toner particles containing a binder resin (A) and a release agent (B), and a carrier liquid (C), wherein the toner particles also contain a compound represented by the above general formula (1). The binder resin (A), the release agent (B) and the compound represented by general formula (1) contained within the liquid developer that represents an embodiment of the present invention are described below in detail.

### (Binder Resin (A))

The binder resin generally has a function of dispersing the release agent and the colorant and the like within the resin, and a binder function during fixation of the toner particles to a substrate such as paper. In one embodiment, examples of binder resins (A) that may be used in the liquid developer include homopolymers of styrene or substitutes thereof, such as polystyrene, poly-p-chlorostyrene and polyvinyltoluene; styrene-based copolymers and crosslinked styrene-based copolymers such as styrene-p-chlorostyrene copolymers, styrene-vinyltoluene copolymers, styrene-(meth)acrylate ester copolymers, styrene-acrylonitrile copolymers, styrene-vinyl alkyl ether copolymers and styrene-butadiene copolymers; as well as polyvinyl chloride, phenolic resins, natural modified phenolic resins, natural resin-modified maleic acid resins, acrylic resins, methacrylic resins, polyvinyl acetate, polyester resins, polyurethane resins, polyamide resins, epoxy resins and petroleum-based resins.

Among these, the binder resin (A) preferably contains at least a polyester resin. The reasons for this preference are that liquid developers which use a polyester resin exhibit excellent grindability and fixability, and when combined with a colorant, also exhibit excellent dispersibility of the colorant. Further, the oxygen atoms that exist in the ester linkages contained in the polyester resin and the (O-A1) region in general formula (1) tend to bind together through the formation of hydrogen bonds. In order to further enhance the compatibility between the binder resin (A) and the compound of general formula (1), it is more preferable that the binder resin (A) has a structure represented by general formula (2) shown below. Further, it is particularly preferable that A2 in the following general formula (2) is the same as A1 in general formula (1).

—(O-A2)ₘ- General formula (2):

(In general formula (2), m represents a natural number from 1 to 10, and A2 represents an alkylene group of 2 to 4 carbon atoms.)

On the other hand, the polyester resin is preferably a thermoplastic polyester, and is more preferably a resin obtained by a polycondensation of a dihydric or trihydric or higher alcohol component and an acid component such as a carboxylic acid or an anhydride thereof.

Examples of dihydric or trihydric or higher alcohol components that can be used favorably include dihydric alcohols such as ethylene glycol, 1,2-propylene glycol 1,3-propylene glycol, 1,3-butanediol, 1,4-butanediol, 2,3-butanediol, 1,4-butenediol, diethylene glycol, triethylene glycol, 1,5-pentanediol, 1,6-hexanediol, neopentyl glycol, 2-ethyl-1,3-hexanediol, 1,4-bis(hydroxymethyl)cyclohexane, bisphenol A, hydrogenated bisphenol A, and bisphenol derivatives represented by general formula (3) shown below; and trihydric or higher alcohols such as glycerol, diglycerol, sorbit, butanetriol, trimethylolpropane, pentaerythritol, dipentaerythritol and tripentaerythritol. These alcohols may be used individually, or a combination of two or more compounds may be used. Among these compounds, a compound having a structure represented by the above general formula (2) is preferred, and a compound having a structure in which A2 in general formula (2) is the same as A1 in general formula (1) is particularly desirable.

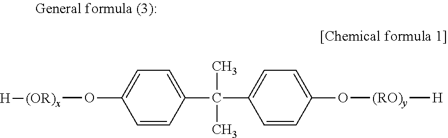

(In general formula (3), R represents an alkylene group of 2 to 4 carbon atoms, x and y each represent an integer of 1 or greater, and the average value of x+y is from 2 to 10.)

Further, among the various aforementioned acid components such as carboxylic acids or anhydrides thereof; examples of divalent acid components include benzene dicarboxylic acids and anhydrides thereof; such as phthalic acid, terephthalic acid, isophthalic acid and phthalic anhydride; alkyl dicarboxylic acids and anhydrides thereof such as succinic acid, adipic acid and sebacic acid; succinic acids that have been substituted with an alkyl group of 16 to 18 carbon atoms, and anhydrides thereof; unsaturated dicarboxylic acids and anhydrides thereof such as fumaric acid, maleic acid, citraconic acid and itaconic acid; as well as cyclohexane dicarboxylic acid and the anhydride thereof, naphthalene dicarboxylic acid and the anhydride thereof; and diphenoxyethane-2,6-dicarboxylic acid and the anhydride thereof. Furthermore, examples of trivalent or higher acid components include trimellitic acid, pyromellitic acid, naphthalene tricarboxylic acid, butane tricarboxylic acid, hexane tricarboxylic acid, benzophenone tetracarboxylic acid, and anhydrides of these carboxylic acids. Trivalent or higher acid components can function as crosslinking components. These acid components may be used individually, or a combination of two or more components may be used.

In one embodiment, ethylene glycol, neopentyl glycol, and bisphenol derivatives represented by general formula (3) (compounds obtained by adding an alkylene oxide to bisphenol A) and the like can be used particularly favorably as the aforementioned alcohol component. Further, for the acid component, dicarboxylic acids such as phthalic acid, terephthalic acid, isophthalic acid, and anhydrides of these acids; succinic acid, n-dodecenylsuccinic acid, and anhydrides of these acids; and fumaric acid, maleic acid and maleic anhydride; and tricarboxylic acids such as trimellitic acid and the anhydride thereof can be used particularly favorably.

Among the various possibilities, in terms of being able to introduce the structure represented by general formula (2) into the binder resin (A), the use of a compound represented by general formula (3), obtained by adding an alkylene oxide (in general formula (3), x+y is preferably from 2 to 4) to bisphenol A, as the alcohol component is particularly desirable.

In those cases where a polyester resin is used as the binder resin (A), a resin synthesized using a conventional synthesis method such as the polycondensation method may be used, or a commercially available product may be used. When the polyester resin is synthesized by the polycondensation method, the molecular weight and the glass transition temperature of the obtained polyester resin can be controlled as desired by adjusting the types of alcohol component and acid component that are reacted, the molar ratio between the two components, and other properties such as the reaction temperature, the reaction time, the reaction pressure and the catalyst. Moreover, the thermal properties and powder properties of the toner particles produced using the polyester resin can also be controlled as desired. Further, when commercially available products are used, by using a combination of two or more products, and adjusting the blend ratio between the products, the thermal properties and powder properties of the toner particles can be controlled. Specific examples of commercially available polyester resins that can be used favorably include DIACRON ER-502 and DIACRON ER-508 (both manufactured by Mitsubishi Rayon Co., Ltd.).

In one embodiment, in terms of enabling an improvement in the grindability and dispersion stability, in terms of having a low dielectric constant, thereby enhancing the chargeability and improving the image density and the image quality, and in terms of facilitating the introduction of a structure represented by general formula (2), it is particularly preferable that the binder resin (A), in addition to the polyester resin described above, also contains at least one type of resin selected from the group consisting of styrene resins, (meth)acrylic resins and styrene-(meth)acrylic copolymer resins (hereafter also referred to as simply styrene/acrylic-based resins). A styrene-(meth)acrylic copolymer resin means a resin obtained by copolymerizing at least one type of styrene-based monomer and at least one type of compound selected from among acrylic acid, methacrylic acid and (meth)acrylic-based monomers. Further, the term “(meth)acrylic” means at least one type selected from among “acrylic” and “methacrylic”. Examples of the “styrene-based monomer” include styrene and substituted styrenes. Examples of the “(meth)acrylic-based monomers” include (meth)acrylate esters.

In those cases where a styrene/acrylic-based resin is used, examples of styrene-based monomers that can be selected favorably include styrene, o-methylstyrene, m-methylstyrene, p-methylstyrene, α-methylstyrene, p-ethylstyrene, 2,4-dimethylstyrene, p-n-butylstyrene, p-tert-butylstyrene, p-n-hexylstyrene, p-n-octylstyrene, p-methoxystyrene, p-phenylstyrene and p-chlorostyrene.

Further, examples of (meth)acrylic-based monomers that can be used favorably in the styrene/acrylic-based resin include various monofunctional monomers, including alkyl group-containing monomers such as methyl (meth)acrylate, ethyl (meth)acrylate, propyl (meth)acrylate, butyl (meth)acrylate, isobutyl (meth)acrylate, pentyl (meth)acrylate, hexyl (meth)acrylate, octyl (meth)acrylate, 2-ethylhexyl (meth)acrylate, nonyl (meth)acrylate, decyl (meth)acrylate, dodecyl (meth)acrylate, methyldodecyl (meth)acrylate, and octadecyl (meth)acrylate;

alkylene oxide chain-containing monomers such as (poly)ethylene glycol mono(meth)acrylate, (poly)propylene glycol mono(meth)acrylate, (poly)butylene glycol mono(meth)acrylate, (poly)(ethylene glycol-propylene glycol) mono(meth)acrylate, (poly)ethylene glycol mono(meth)acrylate monomethyl ether, (poly)ethylene glycol mono(meth)acrylate monobutyl ether, (poly)ethylene glycol mono(meth)acrylate monooctyl ether, (poly)ethylene glycol mono(meth)acrylate monobenzyl ether, (poly)ethylene glycol mono(meth)acrylate monophenyl ether, (poly)ethylene glycol mono(meth)acrylate monodecyl ether, (poly)ethylene glycol mono(meth)acrylate monododecyl ether, (poly)ethylene glycol mono(meth)acrylate monohexadecyl ether, and (poly)ethylene glycol mono(meth)acrylate monooctadecyl ether;

aromatic ring-containing monomers such as phenyl (meth)acrylate and benzyl (meth)acrylate; and

amino group-containing monomers such as dimethylaminoethyl (meth)acrylate and diethylaminoethyl (meth)acrylate. Of the above compounds, the selection of an alkyl group-containing monomer and/or an alkylene oxide chain-containing monomer is particularly preferred.

Furthermore, during the production of the styrene/acrylic-based resin, in order to further increase the molecular weight of the resin, a polyfunctional monomer may be used as a crosslinking agent. Specific examples of such monomers include divinylbenzene, diethylene glycol di(meth)acrylate, triethylene glycol di(meth)acrylate, 1,6-hexanediol di(meth)acrylate, neopentyl glycol di(meth)acrylate and trimethylolpropane tri(meth)acrylate.

In those cases where a styrene/acrylic-based resin is used as the binder resin (A), a resin synthesized by a conventional synthesis method such as a suspension polymerization method, solution polymerization method or emulsion polymerization method may be used, or a commercially available product may be used. When the styrene/acrylic-based resin is synthesized by the polycondensation method, the molecular weight and the glass transition temperature of the obtained styrene/acrylic-based resin can be controlled as desired by adjusting the types of styrene-based monomers, acrylic acid, methacrylic acid and/or (meth)acrylate esters that are used, the molar ratio between the monomers, and other properties such as the reaction temperature, the reaction time, the reaction pressure, the polymerization initiator and/or the crosslinking agent. Moreover, the thermal properties and powder properties of the toner particles can also be controlled as desired. Further, when commercially available products are used, by using a combination of two or more products, and adjusting the blend ratio between the products, the thermal properties and powder properties of the toner particles can be controlled. Specific examples of commercially available styrene/acrylic-based resins that can be used favorably include ALMATEX CPR100, CPR200, CPR300 and CPR600B (manufactured by Mitsui Chemicals, Inc.).

Conventional methods may be used for mixing the polyester resin and the styrene/acrylic-based resin, and suitable methods include a method in which the monomers that constitute either one of the resins are added and polymerized in the presence of the other resin; a method in which the polyester resin and the styrene/acrylic-based resin are prepared separately and then mixed together; and the methods disclosed in JP 3531980 B and JP 2006-178296 A. Of these, in terms of obtaining a more uniformly dispersed binder resin, the method in which the monomers that constitute either one of the resins are added and polymerized in the presence of the other resin can be used favorably. A method in which polycondensation of the polyester resin is performed by bulk polymerization, and the styrene/acrylic-based resin is then synthesized by solution polymerization within a solution obtained by dissolving the polyester resin in a solvent, followed by removal of the solvent is particularly preferred.

Further, in those cases where the polyester resin and the styrene/acrylic-based resin are synthesized separately, or in those cases where a commercially available polyester resin and a commercially available styrene/acrylic-based resin are used, solutions prepared by dissolving each of the resins in a solvent may be mixed together and the solvents then removed, or the resins may be mixed by melt kneading.

### (Acid Value)

The acid value of the binder resin (A) is preferably within a range from 5 to 40 mgKOH/g, and is more preferably from 10 to 30 mgKOH/g. By ensuring that the acid value falls within this range, the acid groups within the binder resin (A) and the (O-A1) region within the compound represented by general formula (1) are more likely to undergo hydrogen bonding, thereby binding the two components together. The acid value can be determined by dissolving the binder resin (A) in a solvent obtained by mixing equal amounts of methyl ethyl ketone and ethanol, subsequently using a potentiometric titration method to perform a titration with a 0.1 mol/L aqueous solution of sodium hydroxide solution, and then calculating the acid value from the amount of the sodium hydroxide aqueous solution required to reach the titration end point. Specifically, the acid value can be measured using an automatic potentiometric titrator AT-610 manufactured by Kyoto Electronics Manufacturing Co., Ltd.

### (Glass Transition Temperature (Tg))

The glass transition temperature of the binder resin (A) is preferably within a range from 50 to 65° C., and is more preferably from 50 to 60° C. The glass transition temperature can be measured using a differential scanning calorimeter DSC-60 PLUS, manufactured by Shimadzu Corporation, using a sample size of 10 mg, and under conditions including a start temperature of 25° C., an end temperature of 150° C. and a rate of temperature increase of 10.0° C./min.

When the glass transition temperature of the binder resin (A) is at least 50° C., the thermal stability of the binder resin (A) improves, and a liquid developer having excellent storage stability can be obtained. Further, when the glass transition temperature is not more than 65° C., the amount of heat required to achieve melting and coalescence of the toner particles during fixation can be kept small, meaning a liquid developer having favorable fixability and cold offset resistance can be obtained.

### (Softening Temperature (T4))

The softening temperature of the binder resin (A) is preferably within a range from 80° C. to 140° C., and is more preferably within a range from 90° C. to 130° C. The softening temperature can be measured using a Flow Tester CFT-500D manufactured by Shimadzu Corporation, under conditions including a start temperature of 40° C., a rate of temperature increase of 6.0° C./min, a test load of 20 kgf, a preheating time of 300 seconds, a die hole diameter of 0.5 mm and a die length of 1.0 mm, with the temperature when 4 mm of the sample of 1.0 g flows out being recorded as the softening temperature (T4).

When the softening temperature of the binder resin (A) is at least 80° C., the hot offset phenomenon (in which melted toner particles are transferred to the printing substrate), which occurs because the toner particles make contact with the surface of the thermocompression bonding roller in a melted state during the fixation process upon image output, meaning the cohesion of the toner particles is less than the adhesive force between the substrate and the thermocompression bonding roller, is unlikely to occur. When the softening temperature is not more than 140° C., favorable fixability is obtained, the grindability improves, and the color development improves.

### (Average Molecular Weight)

In terms of the cold and hot offset resistance, fixability and image quality characteristics, the binder resin (A) preferably has a weight-average molecular weight (Mw) measured by gel permeation chromatography (GPC) of 2,000 to 100,000, and more preferably 5,000 to 50,000. When the weight-average molecular weight (Mw) of the binder resin (A) is at least 2,000, the hot offset resistance, the color reproducibility and the dispersion stability improve, whereas when the weight-average molecular weight is not more than 100,000, the fixability and the cold offset resistance improve. Further, the binder resin (A) may have either a two-peak molecular weight distribution curve containing a specific low-molecular weight polycondensate component and a specific high-molecular weight polycondensate component, or a single-peak molecular weight distribution curve.

The aforementioned molecular weight and molecular weight distribution determined by GPC can be measured, for example, using a Gel Permeation Chromatograph HLC-8220 manufactured by Tosoh Corporation, under the conditions described below. That is, the column is first stabilized inside a 40° C. heat chamber, tetrahydrofuran (THF) is passed through the column as a solvent at this temperature at a rate of 0.6 mL per minute, and 10 μL of a sample solution dissolved in THF is then injected into the column and measured. During measurement of the molecular weight of the sample, the molecular weight distribution of the sample is calculated from the relationship between the count value and the logarithmic value of a calibration curve prepared using a series of monodisperse polystyrene standard samples.

Ten polystyrenes manufactured by Tosoh Corporation and having molecular weights of about 10² to 10⁷ are used as the standard polystyrene samples for preparing the calibration curve. An RI (refractive index) detector is used for the detector. Three TSKgel Super HM-M columns (manufactured by Tosoh Corporation) are used for the column. Further, the sample solution is prepared by adding the sample to THF, and after standing for several hours, mixing the sample thoroughly until no aggregates of the sample remain, and then leaving the sample to stand for at least a further 12 hours. The sample concentration is then adjusted so that the concentration of the resin component is from 0.5 to 5 mg/mL.

The amount of the binder resin (A) contained within the toner particles is preferably from 50 to 95 parts by mass, and more preferably from 65 to 85 parts by mass, per 100 parts by mass of the toner particles. When this amount is at least 50 parts by mass, the fixability and offset resistance improve, whereas when the amount is not more than 95 parts by mass, the grindability of the toner particles and the storage stability of the liquid developer improve.

### (Release Agent (B))

Release agents generally generate a release effect by exuding to the coating film surface during fixation, or by forming an uneven surface. There are no particular limitations on the release agent (B) used in embodiments of the present invention, and conventional materials may be used. Examples include hydrocarbon-based waxes (including polyolefin waxes such as polyethylene wax, polypropylene wax and polybutene wax, and long-chain hydrocarbon waxes such as paraffin wax, microcrystalline wax and Sasol wax) and derivatives thereof, polyester waxes and derivatives thereof, and polyamide waxes and derivatives thereof. These release agents may be used individually, or a combination of two or more release agents may be used. Examples of the derivatives include acid-modified products, hydroxyl group-modified products, aromatic ring-modified products, oxides and halides.

In one embodiment, a hydrocarbon-based wax is preferably used from among the above release agents, and the use of a polyolefin wax or a long-chain hydrocarbon wax is particularly preferred. Reasons for this preference include the fact that liquid developers that use a hydrocarbon-based wax exhibit excellent offset resistance and fixability, and the fact that the polyolefin structures and long-chain hydrocarbon groups contained in hydrocarbon-based waxes have strong hydrophobicity, and therefore are readily compatible with the R1 region in general formula (1) that also has strong hydrophobicity. It is particularly desirable that a partial structure within the release agent (B) and R1 within general formula (1) are the same, as this yields further improvement in the compatibility between the release agent (B) and the compound represented by general formula (1). Specifically, in the case where the release agent (B) is a linear unmodified polyethylene wax, R1 preferably contains a linear aliphatic hydrocarbon group, in the case where the release agent (B) is a polyethylene wax that has been modified with a long-chain alkyl group of 30 to 50 carbon atoms, R1 preferably contains an aliphatic hydrocarbon group (and preferably an alkyl group) of at least 30 carbon atoms, and in the case where the release agent (B) is an aromatic ring structure-containing wax such as a styrene-modified polyethylene wax, R1 preferably contains an aromatic ring structure such as a phenyl group. Further, when the release agent (B) is a linear paraffin wax, R1 preferably contains a linear aliphatic hydrocarbon group.

Commercially available products may also be used as the release agent (B). Examples of polyolefin waxes that can be used particularly favorably include Polywax 500, 1000 and 2080P (manufactured by TOYO ADL Corporation), Sanwax 131P and Sanwax 161P (manufactured by Sanyo Chemical Industries Ltd.), and HI-WAX 800P, HI-WAX 720P, HI-WAX 400P, HI-WAX 320MP, HI-WAX NP055 and HI-WAX NP105 (manufactured by Mitsui Chemicals, Inc.). Examples of other commercially available products that may be used include Paraffin Wax HNP-9 (manufactured by Nippon Seiro Co., Ltd.) and Nissan Electol WEP-5 (manufactured by NOF Corporation)

The melting point of the release agent (B) is preferably from 50 to 160° C., more preferably from 60 to 140° C., and even more preferably from 80 to 130° C. When the melting point is at least 50° C., the heat-resistant storage properties are favorable, and when the melting point is not more than 160° C., cold offset can be suppressed during fixation at low temperature, both of which are desirable.

The amount of the release agent (B), relative to the total amount of the toner particles, is preferably within a range from 1 to 40% by mass, more preferably from 2 to 30% by mass, and even more preferably from 3 to 10% by mass. By ensuring that the amount of the release agent (B) falls within the above range, the offset resistance and the fixability of the liquid developer are both favorable.

### (Compound Represented by General Formula (1))

As already described above in relation to the conventional art, release agents are generally incompatible with binder resins, and the two components are prone to undergo mutual phase separation within the toner particles. As a result, a deterioration in the fixing strength due to melting inhibition during fixation and the cold offset phenomenon tend to occur. Further, in those cases where a colorant is included in the toner particles, the colorant also tends to lose uniformity, causing a deterioration in the density. Accordingly, in an embodiment of the present invention, in order to suppress the phenomena described above, a compound represented by general formula (1) shown below is used.

R1-(O-A1)ₙ-OH General formula (1):

(In general formula (1), n represents a natural number from 1 to 120, R1 represents a hydrocarbon group of 1 to 100 carbon atoms, and A1 represents an alkylene group of 2 to 4 carbon atoms.)

The compound represented by general formula (1) has both a hydrocarbon group and an alkylene oxide group in the molecule. As described above, the former group is readily compatible with the hydrocarbon group that preferably exists in the release agent (B), whereas the latter group is readily compatible with the ester linkage and alkylene oxide group that preferably exist within the binder resin (A). As a result, it is thought that the binder resin (A) and the release agent (B) become mutually miscible and become more readily compatible via the actions of the compound represented by general formula (1).

The compound represented by general formula (1) is a material that is sometimes also used as a resin plasticizer. Generally, mixing a plasticizer into a resin dramatically lowers the softening temperature and glass transition temperature of the resulting mixture. However, in an embodiment of the present invention, even when the compound represented by general formula (1) is used, the softening temperature and the glass transition temperature of the toner particles do not decrease significantly. It is thought that this is because the compound represented by general formula (1) is used in combination with the binder resin (A) and the release agent (B), and therefore functions as a compatibilizer rather than a plasticizer. As mentioned above, even when the compound represented by general formula (1) is used in an embodiment of the present invention, the softening temperature of the toner particles does not decrease, and therefore compared with the case where the compound is used as a plasticizer, the hot offset resistance during printing and the storage stability of the liquid developer are excellent.

As described above, the compound represented by general formula (1) has a property of improving the compatibility of both the binder resin (A) that represents the main components of the toner particles and the release agent (B) that represents the target of dispersion, but the compatibilization performance tends to change depending on R1, A1 and the value of n in the formula.

R1 in the compound represented by general formula (1) must be a hydrocarbon group of 1 to 100 carbon atoms, is preferably an aliphatic hydrocarbon group (which may be linear or branched), and is more preferably a linear aliphatic hydrocarbon group. The aliphatic hydrocarbon group is preferably a saturated aliphatic hydrocarbon group (namely an alkyl group).

For example, R1 is preferably an aliphatic hydrocarbon group of 1 to 80 carbon atoms, more preferably an aliphatic hydrocarbon group of 1 to 60 carbon atoms, even more preferably an aliphatic hydrocarbon group of 1 to 50 carbon atoms, and particularly preferably an aliphatic hydrocarbon group of 1 to 40 carbon atoms. Further, R1 is preferably an aliphatic hydrocarbon group of 10 to 100 carbon atoms, more preferably an aliphatic hydrocarbon group of 20 to 100 carbon atoms, even more preferably an aliphatic hydrocarbon group of 25 to 100 carbon atoms, and particularly preferably an aliphatic hydrocarbon group of 30 to 100 carbon atoms.

Specifically, aliphatic hydrocarbon group of 10 to 80 carbon atoms (which may be linear or branched) are preferred, linear aliphatic hydrocarbon group of 20 to 60 carbon atoms are particularly preferred, and linear aliphatic hydrocarbon group of 25 to 50 carbon atoms are even more desirable. By using a linear aliphatic hydrocarbon group as R1, the hydrophobicity of the R1 region can be further enhanced, resulting in an improvement in the compatibility with the release agent (B).

Further, A1 in the compound represented by general formula (1) must be an alkylene group of 2 to 4 carbon atoms, and an alkylene group of 2 carbon atoms, namely an ethylene group, is particularly desirable. By using an ethylene group as Al, the hydrophilicity of the (O-A1) region can be further enhanced, resulting in an improvement in the compatibility with the binder resin (A).

Moreover, n in the compound represented by general formula (1) must be a natural number from 1 to 120, and is preferably a natural number from 10 to 100, and particularly preferably a natural number from 20 to 95. By selecting a value of n that falls within the above range, the hydrophilicity, the viscosity and the melting point of the compound represented by general formula (1) all fall within favorable ranges. Further, a liquid developer having superior effects can be obtained. The value of n can be determined, for example, by a nuclear magnetic resonance method (NMR).

On the other hand, as a result of intensive investigation, the inventors of the present invention discovered that when the HLB (Hydrophile-Lipophile Balance) value of the compound represented by general formula (1), measured using Griffin's method, is at least 10 but not more than 20, and preferably at least 12 but not more than 18, the aforementioned compatibilization performance is particularly superior. In other words, in one embodiment, when the HLB value is at least 10, the dispersion of the release agent (B) within the binder resin (A) and the compatibilization performance are extremely favorable, meaning a liquid developer can be obtained that exhibits excellent fixing strength and cold offset resistance, and also exhibits excellent chargeability and yields favorable image density and image quality.

Griffin's method used for calculating the HLB value is described below. Griffin's method is generally known for use with nonionic materials, and yields a numerical value from 0 to 20 that indicates the degree of hydrophilicity or hydrophobicity, and is determined using the molecular weight of the target material, in accordance with formula (4) shown below. The smaller the HLB value, the higher the hydrophobicity of the material, whereas the larger the HLB value, the higher the hydrophilicity.

HLB value=20×(sum of molecular weights of hydrophilic portions)±(molecular weight of material) General formula (4):

As shown above, calculation of the HLB value by Griffin's method uses the molecular structure of the material, and therefore in one embodiment, attempting to ensure that the HLB value falls within the preferred range effects the structures and value that RI, A1 and n can adopt in general formula (1). In order to ensure that the HLB value measured by Griffin's method is at least 10 but not more than 20, a hydrophilic group must exist in the compound represented by general formula (1), and it is preferable that either A1 in the formula is an ethylene group, or that R1 includes a hydrophilic group. In one embodiment, as described above, because it is preferable that R1 represents a hydrophobic alkyl group, the former case is preferred selected. Further, when the case in which R1 is an alkyl group and A1 is an ethylene group is selected, the number of carbon atoms in the alkyl group is preferably not more than 3 times, and more preferably not more than 2 times, the value of n in the general formula (1). When the ratio of the number of carbon atoms in the alkyl group relative to the value of n is kept within the above range, the HLB value of the compound is 10 or greater, and it becomes easier to improve the fixing strength, suppress cold offset, and obtain a liquid developer that yields favorable image density and image quality.

Either a compound that has been synthesized using a known synthesis method or a commercially available product may be used as the compound represented by general formula (1). An example of the synthesis method is a method in which an alkylene oxide having an A1 structure is subjected to addition polymerization to an alcohol having an R1 structure in the presence of an alkali catalyst. In this case, the value of n in the general formula (1) can be controlled by adjusting the amounts of the materials used and the reaction conditions.

On the other hand, in those cases where a commercially available product is used as the compound represented by general formula (1), materials known as polyoxyalkylene alkyl ethers or polyoxyethylene phenyl ethers can be used as desired. Examples of commercially available products of the compound represented by general formula (1) in which R1 represents a linear aliphatic hydrocarbon group and A1 represents an ethylene group include:

EMULGEN 150 (R1 carbon atoms=12, n=40), 220 (R1 carbon atoms=16, n=12), 320P (R1 carbon atoms=18, n=13), 420 (R1 carbon atoms=18, n=20), and 430 (R1 carbon atoms=18, n=30), manufactured by Kao Corporation;

UNITHOX 450 (R1 carbon atoms=32, n=about 10), 480 (R1 carbon atoms=34, n=about 40), 490 (R1 carbon atoms=30, n=about 94), 520 (R1 carbon atoms=37, n=3 to 4), 550 (R1 carbon atoms=39, n=12 to 13), and 750 (R1 carbon atoms=about 49, n=about 16), manufactured by TOYO ADL Corporation;

the EMALEX 100 series (R1 carbon atoms=16), 600 series (R1 carbon atoms=18), 700 series (R1 carbon atoms=12), and BHA series (R1 carbon atoms=22), manufactured by Nihon Emulsion Co., Ltd.; and

Newcol 1004, 1006, 1008 and 1020 (R1 carbon atoms=8), Newcol 1305 and 1310 (R1 carbon atoms=13), Newcol 1606 and 1607 (R1 carbon atoms=16), Newcol 1807, 1820 and 1860 (R1 carbon atoms=18), and Newcol 2302, 2303, 2305, 2307, 2308, 2310, 2312, 2314, 2318, 2320, 2327, 2330, 2344, 2360 and 2399S (R1 carbon atoms=12 to 13), manufactured by Nippon Nyukazai Co., Ltd.

Further, examples of commercially available products in which R1 represents a branched aliphatic hydrocarbon group and A1 represents an ethylene group include:

the EMALEX 500 series (R1=oleyl group), CS series (R1=cholesteryl group), 1600 series (R1=isocetyl group), 1800 series (R1=isostearyl group), OD series (R1=octyldodecyl group), and 2400 series (R1=decyltetradecyl group), manufactured by Nihon Emulsion Co., Ltd.; and

Newcol NT-3, 5, 7, 9, 12, 15, 20, 30, 40 and 50 (R1=secondary alkyl group), manufactured by Nippon Nyukazai Co., Ltd.

Furthermore, examples of commercially available products in which R1 represents a linear aliphatic hydrocarbon group and A1 represents an ethylene group and a propylene group include:

the EMALEX DAPE series (R1 carbon atoms=10), manufactured by Nihon Emulsion Co., Ltd.;

Newcol 1008F1 (R1 carbon atoms=8), 1308FA (RI carbon atoms=13), 1902Y (R1 carbon atoms=9), 2300FC, 2303Y, 2304Y, 2306Y, 2308Y and 2314Y (R1 carbon atoms=12 to 13), manufactured by Nippon Nyukazai Co., Ltd.; and

LIONOL L535, 745, 785 and 950 (R1 carbon atoms=1213), LIONOL NH1509 (R1 carbon atoms=14 to 15), LIONOL TD730, 2180, TDL20, TDL30 and TDL50 (R1 carbon atoms=13).

Furthermore, examples of products in which R1 includes an aromatic hydrocarbon group having an aromatic ring structure include TRITON X15 (n=1.5), X35 (n=3), X45 (n=4.5), X100 (n=9.5), X102 (n=12), X114 (n=7.5), X165 (n=16), X305 (n=30), X405 (n=35) and X705 (n=55) (in each product, R=octylphenyl group and A=ethylene group), manufactured by The Dow Chemical Company;

NP-2 (n=2), 5 (n=5), 7 (n=7), 15 (n=15) and 20 (n=20) (in each product, R=nonylphenyl group and A=ethylene group), manufactured by Nikko Chemicals Co., Ltd.; and

Newcol 504, 506, 509, 516, 560, 562, 564, 565, 566 and 568 (in each product, R=nonylphenyl group and A=ethylene group), Newcol 610, 703, 704, 706, 707, 708, 709, 710, 711, 712, 714, 719, 723, 729, 733, 740, 747, 780, 2604, 2607, 2609 and 2614 (in each product, R=polycyclic phenyl group and A=ethylene group), Newcol 707F, 710F, 714F, 2608F, 2600FB, 2616F and 3612FA (in each product, R=polycyclic phenyl group and A=ethylene group and propylene group), Newcol B10 and B13 (in each product, R=aryl group and A=ethylene group), and Newcol CMP-1, 6, 8 and 11 (in each product, R=cumyl group and A=ethylene group), manufactured by Nippon Nyukazai Co., Ltd.

Among the above products, examples of commercially available products in which R1 is an aliphatic hydrocarbon group of 1 to 50 carbon atoms, A1 is an ethylene group, n is from 10 to 100, and the HLB value measured by Griffin's method is at least 10 but not more than 20, which can be used favorably as the compound represented by general formula (1), include:

EMULGEN 320P, 420, 430, 150 and 220, manufactured by Kao Corporation;

UNITHOX 450, 480, 490, 550 and 750, manufactured by TOYO ADL Corporation;

EMALEX 107, 112, 115, 117, 120, 125, 610, 611, 612, 615, 620, 705, 707, 709, 710, 712, 715, 720, 725, 730, BHA20 and BHA30, manufactured by Nihon Emulsion Co., Ltd.; and

Newcol 1004, 1006, 1008, 1020, 1305, 1310, 1606, 1607, 1807, 1820 and 1860, and Newcol 2305, 2307, 2308, 2310, 2312, 2314, 2318, 2320, 2327, 2330, 2344, 2360 and 2399S, manufactured by Nippon Nyukazai Co., Ltd.

Of the above products, examples of commercially available products in which R1 is an aliphatic hydrocarbon group of 20 to 60 carbon atoms, which can be used favorably as the compound represented by general formula (1), include UNITHOX 450, 480, 490, 550 and 750, manufactured by TOYO ADL Corporation; and EMALEX BHA20 and BHA30, manufactured by Nihon Emulsion Co., Ltd.

In those cases where the compound represented by general formula (1) is a solid at normal temperatures, the melting point is preferably from 50 to 130° C., more preferably from 55 to 100° C., and even more preferably from 60 to 90° C. When the melting point is at least 50° C., the heat-resistant storage properties are favorable, and when the melting point is not more than 130° C., the meltability is superior, making the compound readily compatible with the binder resin (A) and the release agent (B), and improving the functionality of the compound as a compatibilizer.

Further, the amount of the compound represented by general formula (1), when the amount of the release agent (B) is deemed to be 100% by mass, is preferably from 2 to 50% by mass, more preferably from 3.5 to 35% by mass, and even more preferably from 5 to 20% by mass. By ensuring that the amount is at least 2% by mass, the compatibilization of the release agent (B) relative to the binder resin (A) can be improved, while still ensuring that the release effect of the release agent (B) manifests readily. Further, by ensuring that the amount is not more than 50% by mass, the compound represented by general formula (1) contributes to the compatibilization of the release agent (B), and therefore excessive softening of the binder resin (A) can be suppressed, and any deterioration in the storage stability of the liquid developer can also be suppressed. If the amount exceeds 50% by mass, then the compound represented by general formula (1) may sometimes have a plasticizer effect.

One example of a method for investigating whether or not the compound represented by general formula (1) is functioning as a compatibilizer for the binder resin (A) and the release agent (B) is a method that involves producing the toner particles containing the binder resin (A) and the release agent (B) with and without including the compound represented by general formula (1), and then inspecting transmission electron microscope (TEM) images of the toner particles samples to ascertain the dispersive state of the release agent (B) in the binder resin (A). In other words, if the domain size of the release agent (B) in the toner particles containing the compound represented by general formula (1) (hereafter also referred to as “the toner particles (1)”) is smaller than the domain size of the release agent (B) in the toner particles that do not contain the compound represented by general formula (1) (hereafter also referred to as “the toner particles (2)”), then it can be stated that the compound represented by general formula (1) is functioning as a compatibilizer. In the comparison of the toner particles (1) and the toner particles (2), the domain size of the toner particles (1) is preferably at least 10% smaller, more preferably at least 20% smaller, and even more preferably 30% or more smaller than the domain size of the toner particles (2) (namely, it is preferable that 0<domain size of toner particles (1)≤domain size of toner particles (2)×0.9, more preferable that 0<domain size of toner particles (1)<domain size of toner particles (2)×0.8, and even more preferable that 0<domain size of toner particles (1)<domain size of toner particles (2)×0.7). In the comparison, the toner particles used as the toner particles (2) may be prepared in the same manner as the toner particles (1), with the exceptions of not including the compound represented by general formula (1), and increasing the amount of the binder resin (A) by the same amount as that of the compound represented by general formula (1). In those cases where the compound represented by general formula (1) functions as a compatibilizer, the toner particles contain the binder resin (A) and the release agent (B) in a compatible arrangement.

The domain size can be measured using a transmission electron microscope (TEM). Specifically, toner particles that have been encapsulated in an epoxy resin are cut to form a thin plate-like toner particles sample. Subsequently, this toner particles sample is inspected at a magnification of 5,000 to 10,000× (for example, 7,500×) using a transmission electron microscope, and the release agent (B) domain is calculated as an equivalent circle diameter at 50 random points. Following these calculations, an average value of the obtained equivalent circle diameters is determined, and this average value is deemed to be the domain size of the release agent (B). In order to improve the visibility of the release agent (B) domain, the toner particles sample may be stained using ruthenium or osmium or the like if necessary.

From the viewpoint of ensuring that the effects of the compound represented by general formula (1) manifest satisfactorily, the compound represented by general formula (1) preferably exists within the interior of the toner particles. Accordingly, preferred toner particles contain the compound represented by general formula (1) within the interior of the particles. In this regard, the amount of the compound represented by general formula (1) that exists within the interior of the toner particles, when the amount of the release agent (B) is deemed to be 100% by mass, is preferably at least 2.5% by mass, more preferably at least 3% by mass, even more preferably at least 3.5% by mass, and particularly preferably 4% by mass or greater. By ensuring that the amount falls within the above range, the compatibilization of the release agent (B) relative to the binder resin (A) can be improved, while still ensuring that the release effect of the release agent (B) manifests readily. The upper limit is as described above, and for example, may be not more than 50% by mass, not more than 35% by mass, or 20% by mass or less.

The amount of the compound represented by general formula (1) that exists within the interior of the toner particles can be determined as the amount of the compound in the toner particles following removal of any compound represented by general formula (1) adhered to the surfaces of the toner particles. For example, the amount can be determined using the following method, namely a method in which the proportion of the compound represented by general formula (1) that exists within the interior of the toner particles is calculated from the amount added and the like of the compound represented by general formula (1).

In the liquid developer, it is preferable that the compound represented by general formula (1) exists mainly within the interior of the toner particles. The expression “exists mainly within the interior of the toner particles” means, for example, that at least 50% by mass of the compound represented by general formula (1) contained within the liquid developer exists within the interior of the toner particles, and does not necessarily prohibit existence of the compound represented by general formula (1) within the carrier liquid (C), or adhesion of the compound represented by general formula (1) to the surfaces of the toner particles. From the viewpoint of achieving superior effects, it is preferable that at least 60% by mass of the compound represented by general formula (1) exists within the interior of the toner particles, and a value of at least 70% by mass is particularly preferable, with a value of 80% or more being extremely desirable. The upper limit may be 100% by mass.

The proportion of the compound represented by general formula (1) that exists within the interior of the toner particles can be determined, for example, using the following method.

First, the amount of the compound represented by general formula (1) that exists within the carrier liquid (C), and the amount of the compound represented by general formula (1) adhered (for example, adsorbed) to the surfaces of the toner particles are quantified. Specifically, a centrifugal separation method (for example, 25° C., 15 minutes at 20,000 rpm) is used to separate the liquid developer into the toner particles and the carrier liquid (C), and the amount of the compound represented by general formula (1) contained in the supernatant carrier liquid (C) is quantified using a high performance liquid chromatograph-mass spectrometer (for example, LCMS-8050, manufactured by Shimadzu Corporation). Further, isopropanol is added to the sediment obtained following separation, and following thorough mixing, another centrifugal separation is performed under the same conditions as above, thereby extracting the compound represented by general formula (1) that had been adhered to the surfaces of the toner particles. Subsequently, the amount of the compound represented by general formula (1) contained in the supernatant isopropanol is quantified using the same method as above.

Next, the total of the amount of the compound represented by general formula (1) that exists in the carrier liquid (C) and the amount of the compound represented by general formula (1) adhered to the surfaces of the toner particles, and the amount added of the compound represented by general formula (1) during preparation of the liquid developer are used to determine the proportion of the compound represented by general formula (1) that exists within the interior of the toner particles.

Quantification can be performed by dissolving fixed amounts of the compound represented by general formula (1) to prepare calibration curves using both the carrier liquid (C) and isopropanol, and then comparing the results of analyzing the sample with the calibration curves.

Although described below in further detail, one method that can be used favorably for incorporating the compound represented by general formula (1) within the interior of the toner particles is a method in which, during the step of producing the toner particles, the compound represented by general formula (1) is added and mixed together with the binder resin (A) and the release agent (B). As described above, the compound represented by general formula (1) is used to achieve mixing and compatibilization of the binder resin (A) and the release agent (B). From the viewpoint of ensuring this effect is satisfactorily realized, the method described above can be used particularly favorably. The obtained toner particles contain the compound represented by general formula (1) within the interior of the particles. For example, if a method is used in which toner particles containing the binder resin (A) and the release agent (B) are first produced, and the compound represented by general formula (1) is then added to the carrier liquid (C), then the effects of the compound represented by general formula (1) are more difficult to achieve. For example, in one embodiment, toner particles in which the compound represented by general formula (1) exists mainly at the surface are removed from the toner particles used in the liquid developer. Here, “toner particles in which the compound represented by general formula (1) exists mainly at the surface” means particles in which at least 50% by mass of the added compound represented by general formula (1) exists as the surfaces of the toner particles. An example of such particles is toner particles obtained by simply adsorbing the compound represented by general formula (1) to the particle surfaces.

### (Toner Particles)

The toner particles used in the liquid developer may also employ a colorant, a dispersant, and a charge control agent and the like, in addition to the binder resin (A), the release agent (B) and the compound represented by general formula (1).

### (Colorant)

Various yellow, magenta, cyan, black, white and other special-color organic pigments, organic dyes and salt-forming compounds thereof, carbon blacks, and titanium oxide and the like described below may be used favorably as the colorant. These colorants may be used individually, or a combination of two or more colorants may be used. Further, the colorant is preferably insoluble in the carrier liquid (C) described below.

For the yellow colorant, the use of a yellow organic pigment or a salt-forming compound of a yellow dye is preferred. Examples of yellow organic pigments that may be used include benzimidazolone compounds, condensed azo compounds, isoindolinone compounds, anthraquinone compounds, quinophthalone compounds, azo metal complex compounds, methine compounds, and allyl amide compounds. Specific examples of colorants that can be used favorably include C. I. Pigment Yellow 12, 13, 14, 15, 17, 62, 74, 83, 93, 94, 95, 97, 109, 110, 111, 120, 127, 128, 129, 138, 139, 147, 150, 155, 168, 174, 176, 180, 181, 185, 191 and 213. Among these, the use of a quinophthalone compound, condensed azo compound or benzimidazolone compound is preferred. Further, examples of salt-forming compounds of yellow dyes that may be used include salt-forming compounds of acid dyes and salt-forming compounds of basic dyes. These colorants may be used individually, or a combination of two or more colorants may be used.

For the magenta colorant, the use of a magenta organic pigment or a salt-forming compound of a magenta dye is preferred. Examples of magenta organic pigments that may be used include condensed azo compounds, diketopyrrolopyrrole compounds, anthraquinone and quinacridone compounds, lake compounds of basic dyes such as rhodamine lake, naphthol compounds, benzimidazolone compounds, thioindigo compounds, and perylene compounds. Specific examples of colorants that can be used favorably include C. I. Pigment Red 2, 3, 5, 6, 7, 23, 48:2, 48:3, 48:4, 57:1, 81, 81:1, 81:2, 81:3, 81:4, 122, 144, 146, 147, 150, 166, 169, 177, 184, 185, 202, 206, 209, 220, 221, 254, 255, 268 and 269, and C. I. Pigment Violet 1 and 19. Among these, the use of a quinacridone compound or a naphthol-based pigment or the like is preferred, and specific examples of preferred materials include naphthol AS (such as C. I. Pigment Red 146 and 269), quinacridone (such as C. I. Pigment Red 122 and C. I. Pigment Violet 19), and carmine 6B (such as C. I. Pigment Red 57:1). Further, examples of salt-forming compounds of magenta dyes that may be used include salt-forming compounds of rhodamine-based acid dyes and salt-forming compounds of rhodamine-based basic dyes. These colorants may be used individually, or a combination of two or more colorants may be used.

For the cyan colorant, the use of a cyan or blue organic pigment, a salt-forming compound of a cyan or blue dye, or an oil-soluble cyan or blue dye is preferred. Examples of cyan or blue organic pigments that may be used include copper phthalocyanine compounds and derivatives thereof, anthraquinone compounds, and basic dye lake compounds. Specific examples of colorants that can be used favorably include C. I. Pigment Blue 1, 7, 15, 15:1, 15:2, 15:3, 15:4, 15:6, 60, 62 and 66. Among these, the use of copper phthalocyanine compounds such as C. I. Pigment Blue 15:3 is preferred. Further, combinations of an organic pigment and a triarylmethane-based dye-derived compound may also be used. Moreover, a green pigment may be used as a supplemental color in addition to the cyan or blue organic pigment for the purpose of hue adjustment. In such cases, examples of green pigments that can be used favorably include halogenated phthalocyanines such as C. I. Pigment Green 7 and 36. These colorants may be used individually, or a combination of two or more colorants may be used.

For the black colorant, in terms of cost and handling properties, the use of carbon blacks, organic black pigments such as perylene black, and organic black dyes such as nigrosin dye and azo metal complex dyes is preferred. Examples of carbon blacks that may be used include furnace black, channel black, acetylene black, and biomass-derived carbon black. Among these, furnace black carbon or biomass carbon have image characteristics that include a reduced level of fogging (staining of white portions), and are therefore preferred. On the other hand, in terms of the nigrosin dye, the use of a dye having a volume-average particle size of 0.5 to 2 μm obtained by micronization of a nigrosin base by wet grinding and the like is preferred. This type of micronized nigrosin dye has a luster, and thus enables a glossy black color to be achieved. These colorants may be used individually, or a combination of two or more colorants may be used.

In order to obtain a black color having good image density and contrast, a colorant prepared by adding 1 to 10 parts by mass of a blue or violet colorant to 100 parts by mass of a black colorant is preferably used as the black colorant. A halogen-free metal phthalocyanine blue compound, triarylmethane compound, quinacridone violet pigment or dioxazine violet pigment or the like is preferably used as the blue or violet colorant. Phthalocyanine blue compounds and triarylmethane compounds have positive charging characteristics, and this is also effective in obtaining good black toner particles. Specific examples of blue or violet colorants that can be used favorably include C. I. Pigment Blue 1 and 15:3, and C. I. Pigment Violet 19 and 23. These colorants may be used individually, or a combination of two or more colorants may be used.

Moreover, a black liquid developer can also be obtained by mixing a plurality of color pigments such as yellow, magenta, cyan, green and violet pigments. In such cases, it is preferable that a black colorant is either not used at all, or used in a proportion of 5 to 40% by mass relative to the total mass of colorants.

Further, for the white colorant, the use of titanium oxide, which has a large refractive index, is chemically and physically stable, and exhibits excellent hiding power and tinting strength, is preferred. The titanium oxide may have been treated with an oxide of silicon, aluminum, zirconium or titanium, or with an organometallic compound or an organic compound. Besides titanium oxide, other inorganic compounds such as basic lead carbonate, zinc oxide and strontium titanate, and organic compounds such as hollow resin microparticles may also be used.

In one embodiment, the total amount of colorant contained in the toner particles varies depending on the type of binder resin (A) being used, but is typically from 5 to 40 parts by mass, and preferably from 10 to 30 parts by mass per 100 parts by mass of the toner particles. Further, when titanium oxide is used as the colorant, the amount is preferably from 10 to 70 parts by mass, and more preferably from 20 to 50 parts by mass, per 100 parts by mass of the toner particles.

### (Pigment Dispersant)

In those cases where the toner particles contain a colorant, a pigment dispersant may also be used for the purpose of improving the dispersibility of the colorant in the toner particles. Examples of pigment dispersants that can be included internally within the toner particles include polyamine-based resin dispersants such as Solsperse 24000SC and Solsperse 32000 (manufactured by The Lubrizol Corporation), and AJISPER PB821 and AJISPER PB822 (manufactured by Ajinomoto Fine-Techno Co., Inc.); and acrylic copolymer resin dispersants such as BYK-116 (manufactured by BYK-Chemie GmbH). Particularly in those cases where production is performed using a color masterbatch having a high pigment concentration, addition of a pigment dispersant during production of the masterbatch is preferable. In terms of improving the dispersibility of the toner particles, the amount added of the pigment dispersant is preferably at least 3 parts by mass, and more preferably 5 parts by mass or greater, per 100 parts by mass of the colorant. Further, in terms of improving the grindability and productivity of the toner particles, the amount of the pigment dispersant is preferably not more than 40 parts by mass, and more preferably 30 parts by mass or less, per 100 parts by mass of the colorant.

### (Charge Control Agent)

If necessary, the toner particles within the liquid developer may include a colorless or light-colored charge control agent, provided there is no adverse effect on the color tone. The charge control agent may be either a positive charge control agent or a negative charge control agent depending on the polarity of the electrostatically charged image on the electrostatic latent image support that is to be developed. In one embodiment of the liquid developer, the toner particles preferably adopt a positive charge, and therefore a positive charge control agent is typically used.

Examples of positive charge control agents include quaternary ammonium salt compounds (such as tributylbenzylammonium-1-hydroxy-4-naphthosulfonate), organotin oxides (such as dioctyltin oxide), diorganotin borates (such as dibutyltin borate), and electron donor substances such as amino group-containing polymers, and these positive charge control agents may be used individually, or a combination of two or more charge control agents may be used. Further, triarylmethane-based colorants can also be used as positive charge control agents in a similar manner. Moreover, instead of using an aforementioned positive charge control agent, a resin-based charge control agent may also be used. Examples of resin-based charge control agents include copolymers of acryloylamino-2-methyl-1-propanesulfonic acid and a vinyl-based monomer such as styrene or an acrylate ester. In one embodiment, the resin-based charge control agent is typically added in an amount of 1 to 20 parts by mass per 100 parts by mass of the binder resin (A).

### (Dispersant)

A dispersant is generally used by addition to the carrier liquid containing the toner particles to uniformly disperse the toner particles, and also has the effect of improving the developing characteristics. When added to the carrier liquid to disperse the toner particles, it is assumed that the dispersant adsorbs to the binder resin portions on the surfaces of the toner particles, and particularly to polyester resin portions which exhibit an excellent dispersion-stabilizing effect. Any material that is capable of stably dispersing the toner may be used as the dispersant, and either a material synthesized using a conventional synthesis method or a commercially available product may be used. Specifically, surfactants and polymeric dispersants and the like may be used as desired, and among such dispersants, the use of a polymeric dispersant having at least one type of structure selected from among alkyl groups of 9 to 24 carbon atoms, aromatic amino groups, aliphatic amino groups, heterocyclic nitrogen-containing groups, heterocyclic oxygen-containing groups, heterocyclic sulfur-containing groups and pyrrolidone groups is preferred. Examples of commercially available products include Antaron V-216 and Antaron V-220 (both product names, manufactured by GAF/ISP Chemicals, Inc.) and Solsperse 13940 and Lubrizol 2153 (both product names, manufactured by The Lubrizol Corporation).

### (Carrier Liquid (C))

The carrier liquid (C) used in the liquid developer is preferably an aliphatic hydrocarbon. Examples of this aliphatic hydrocarbon include linear paraffin-based hydrocarbons, isoparaffin-based hydrocarbons and naphthene-based hydrocarbons. Among these, paraffin-based hydrocarbons for which the amount of residual aromatic hydrocarbons is extremely small are preferred. Further, compounds having lipophilicity and chemically stable insulating properties are preferable. Furthermore, the carrier liquid is preferably chemically inert relative to the substances and devices used in the image forming apparatus, and particularly the members used in the developing process such as the photoreceptor and the surrounding members.

The dry point in the distillation range of the carrier liquid (C) is preferably within a range from 230 to 360° C., and particularly preferably within a range from 240 to 320° C. When the dry point is at least 230° C., the liquid developer does not dry at normal temperatures, compatibility with the dispersant remains high, and favorable storage stability can be maintained. Further, because no precipitation of solid matter occurs, there is no fixation of solid matter to the developing roller or the control blades around the photoreceptor, meaning image contamination does not occur. Further, when the dry point is not higher than 360° C., removal of the carrier liquid is easy, and excellent fixability can be obtained with no impairment of the melting or coalescence of the toner particles containing the dispersant. The dry point in the distillation range is determined using the method prescribed in ASTM D86, ASTM D1078 and JIS K2254.

In terms of the insulating properties of the carrier liquid (C), the dielectric constant is preferably not more than 10, more preferably from 1 to 5, and even more preferably from 2 to 3. Further, the electrical resistivity is preferably at least 10⁹ Ω·cm, more preferably 10¹⁰ Ω·cm or greater, and particularly preferably within a range from 10¹¹ to 10¹⁶ Ω·cm. Here, the electrical resistivity can be measured using a combination of a Universal Electrometer MMA-II-17D and an electrode for liquids LP-05 manufactured by Kawaguchi Electric Works Co., Ltd. In those cases where the electrical resistivity is at least 10⁹ Ω·cm, the chargeability of the toner particles improves, meaning satisfactory image density can be obtained, and the color development properties improve.

The carrier liquid (C) has a kinematic viscosity (ASTM D445) that is preferably within a range from 1 to 25 mm²/s, and particularly preferably within a range from 3 to 15 mm²/s. This range is preferred in terms of enabling movement of the charged particles during developing, and enabling the carrier liquid to be easily removed in the fixation step from the medium on which the image has been formed. When the kinematic viscosity is at least 1 mm²/s, the transferability of the liquid developer to the developing roller is excellent, and the image density and color development improve. Further, when the kinematic viscosity is not more than 25 mm²/s, the mobility of the toner particles improves, electrophoresis can occur more readily, and the image density and color reproducibility improve.

Specific examples of preferred carrier liquids include branched paraffin solvent mixtures such as the products Shellsol™ (manufactured by Shell Chemicals LP), IP Solvent 2028 (manufactured by Idemitsu Kosan Co., Ltd.), and Isopar M and Isopar L (manufactured by Exxon Mobil Corporation), and naphthene-based hydrocarbons such as Exxsol D40, Exxsol D110 and Exxsol D130 (manufactured by Exxon Mobil Corporation).

### (Liquid Developer Set)

The liquid developer that represents an embodiment of the present invention may be used as a single color, or depending on the application, a liquid developer set containing a plurality of selected colors may be used. Although there are no particular limitations of the combination used, by using the three colors of cyan, yellow and magenta, full color images can be obtained. Further, by also including a black liquid developer, the level of blackness can be improved, and the legibility of text and the like can be improved. Moreover, by also adding special colors or light colors such as orange and green, the color reproducibility can be improved. In addition to the above, a white liquid developer may also be used in the case of a transparent or colored printing substrate. Moreover, in order to improve the resistance or aesthetics of the printed material, a transparent liquid developer containing no colorant may also be used in addition to the above liquid developers.

### (Production Method)

The method for producing a liquid developer according to an embodiment of the present invention may use a conventionally known method, and a conventionally used method such as the melt kneading method, suspension polymerization method or emulsion polymerization method may be selected as desired, but from the viewpoints of productivity and environmental impact, the melt kneading method is preferably selected. In particular, the viscosity when mixing the various materials is higher in the melt kneading method than in the other methods, and therefore high shearing forces can be applied during mixing, which can dramatically enhance the degree of compatibility between the binder resin (A) and the release agent (B), and enables the melt kneading method to be used particularly favorably. By using the melt kneading method, the toner particles are obtained as a mixture containing the binder resin (A), the release agent (B) and the compound represented by general formula (1), and therefore the compound represented by general formula (1) can be incorporated favorably within the interior of the toner particles.

An example of a preferred method for producing the liquid developer is described below.

(1) Preparation of Color Masterbatch for Toner Particles (when a Colorant is Also Used)

The binder resin (A) and the colorant are kneaded using hot rollers or the like in a ratio that yields a concentration of the colorant of 10 to 70% by mass relative to the total mass of the masterbatch, and following cooling, coarse grinding is performed to obtain a color masterbatch. Further, in addition to the binder resin (A) and the colorant, a pigment dispersant or a colorant derivative or the like may also be added.

### (2) Preparation of Chips for Toner Particles (Dilution of Color Masterbatch)

The color masterbatch obtained in (1), the binder resin (A), the release agent (B) and the compound represented by general formula (1) are mixed and preliminarily dispersed using a Super Mixer or the like, and melt kneading is then performed to dilute and disperse each of the above materials within the binder resin (A), thus obtaining chips for the toner particles. Further, a pigment dispersant or a charge control agent or the like may also be added during this preliminary dispersion step or melt kneading step. Because the compound represented by general formula (1) is a material that has particular effect during mixing of the binder resin (A) and the release agent (B), the compound represented by general formula (1) is preferably added together with the release agent (B) during this preliminary dispersion step and/or melt kneading step. Compared with a production method in which the compound represented by general formula (1) is not mixed during this step, but is rather added together with a solvent or the like, separately from the binder resin (A) and the release agent (B), in the wet grinding step described below, performing addition of the compound represented by general formula (1) in the step described above ensures that the effects of the compound represented by general formula (1) can be satisfactorily obtained. Furthermore, addition in this step is also desirable in terms of preventing the compound represented by general formula (1) from functioning as a surfactant, and thereby preventing any changes in the physical properties such as the surface tension of the liquid developer that may cause a deterioration in the printability.

The steps (1) and (2) may be combined, and in such a case, the color masterbatch step of (1) is not performed, and all the materials may be combined during the preliminary dispersion of step (2) to prepare the chips for the toner particles. A conventional kneading device such as a pressurized kneader, or a single-screw or twin-screw extruder may be used for the melt kneading. The chips for the toner particles are preferably ground to a particle size of 5 mm or less. This grinding may be performed by a conventional method, but a method in which coarse grinding is first performed using a hammer mill or a sample mill or the like, and fine grinding is then performed using a jet stream grinder such as a jet mill or a mechanical grinder such as a turbo mill is preferred.

### (3) Wet Grinding of Toner Particles

The chips for the toner particles obtained in (2) are dispersed in a solvent with the same composition as the carrier liquid (C), and ground using a wet grinder (dispersion device) to obtain the average particle size described below. Further, at this time, it is effective to add a dispersant that adsorbs to the toner particles and imparts better dispersion stability. In such a case, the dispersant adsorbs to the toner particles during the wet grinding and dispersion step, and also provides charge stabilization. When performing wet grinding (dispersion), cooling is preferably performed so that the temperature during grinding does not exceed 50° C. When the temperature is not more than 50° C., melting of the toner particles does not occur, and the particle size distribution can be controlled.

Examples of wet grinders that can be used for the wet grinding include container-driven medium mills and medium stirring mills that use a grinding medium. Examples of the container-driven medium mills include rolling ball mills and planetary ball mills, whereas examples of the medium stirring mills include stirred tank mills and circulation tank mills. Any of the above mills are effective, but use of a medium stirring mill is preferable in terms of grinding performance and control of the particle size distribution. Moreover, using a wet grinder that is classified as a horizontal circulation tank mill, in which a closed horizontal tank is filled with microbeads as the medium, is preferred in terms of enabling precise wet grinding. By using a horizontal wet grinder, the grinding medium in the grinder is substantially unaffected by gravity, and therefore uniform dispersion that is close to ideal can be achieved inside the grinder. One specific example is the Dyno-Mill manufactured by Shinmaru Enterprises Corporation.

In the wet grinder, examples of factors which significantly influence the grinding properties include the type of grinding media used, the particle size of the grinding media, the fill rate of the dispersion media inside the grinder, the type of agitator discs used, the solution concentration of the sample being ground, and the type of solvent used. Among these, the type of grinding media used and the particle size of the grinding media contribute significantly to the grindability.

The type of grinding media used may be selected in accordance with factors such as the viscosity and specific gravity of the toner particles, and the particle size desired following grinding and dispersion, and examples of grinding media that can be used include beads of glass, zircon, zirconia, alumina, and titania and the like, but in terms of achieving more favorable grinding properties, the use of zirconia beads or zircon beads is preferable. Further, grinding media having a diameter within a range from 0.1 to 3.0 mm can be used, and of these, a diameter within a range from 0.3 to 1.5 mm is preferred. When the diameter is at least 0.1 mm, the load inside the grinder is reduced, melting of the toner particles due to heat generation is prevented, and favorable grinding performance can be achieved. When the diameter is not more than 3.0 mm, satisfactory grinding can be performed. The fill rate of the grinding media inside the wet grinder is preferably from 40 to 90% by mass.

### (4) Preparation of Liquid Developer

The carrier liquid (C), and if necessary a dispersant, are added to and mixed with the mixture obtained in (3) containing the toner particles, the carrier liquid (C) and a dispersant where necessary, and the concentration of the toner particles is then adjusted to complete preparation of the liquid developer.

### (Physical Properties of Liquid Developer)

The average particle size (D50) of the toner particles is preferably from 0.5 to 4 μm, and more preferably from 1 to 3 μm. The particle size is measured using a laser diffraction/scattering particle size analyzer Microtrac HRA manufactured by Nikkiso Co., Ltd., and the average particle size (D50) represents the particle size at 50% in the cumulative distribution.

The concentration of toner particles in the liquid developer is preferably from 10 to 30% by mass, and more preferably from 12 to 25% by mass, relative to 100% by mass of the total liquid developer. When the concentration is at least 10% by mass, removal of the carrier liquid (C) is easy and the fixation of the toner particles improves. When the concentration is not more than 30% by mass, the viscosity of the liquid developer is lowered, the mobility of the toner particles improves, and satisfactory image density can be obtained. Moreover, aggregation of the toner particles weakens, thus improving the storage stability.

The viscosity (η) of the liquid developer is preferably from 5 to 180 mPa·s. When the viscosity (η) is at least 5 mPa·s, the precision of the developed image improves, whereas when the viscosity is not more than 180 mPa·s, the mobility of the toner particles during developing improves, enabling high-speed developing, and satisfactory image density can be achieved. The viscosity (η) of the liquid developer can be measured, for example, using an E-type viscometer TV-22 or the like manufactured by Toki Sangyo Co., Ltd. Furthermore, the electrical resistivity of the liquid developer is preferably from 10¹⁰ to 10¹⁵ Ω·cm. When the electrical resistivity falls within this range, maintaining the electrostatic latent image on the photoreceptor is easier. The electrical resistivity can be measured in the same manner as that described above for the carrier liquid.

### (Method for Producing Printed Material)

The method for producing printed material according to an embodiment of the present invention is a method that includes a step of performing printing using the liquid developer of the embodiment described above. Specifically, printed material is produced by conducting a step of forming an electrostatic latent image on an electrostatic latent image support such as an amorphous silicon photoreceptor, a step of supplying the liquid developer of the embodiment described above to the electrostatic latent image support to develop the electrostatic latent image, a step of transferring the developed toner image to a printing substrate, a step of drying the carrier liquid (C) on the printing substrate, and a step of fixing the toner particles to the printing substrate.

After the step of developing the electrostatic latent image and prior to the step of transferring the developed toner image to the printing substrate, a step of temporarily transferring the developed toner image to an intermediate transfer body or the like may be included. Further, the step of drying the carrier liquid (C) on the printing substrate and the step of fixing the toner particles to the printing substrate may be conducted simultaneously or conducted separately, but from the viewpoint of improving the fixability, the latter is preferred. Moreover, when production of printed material is performed using liquid developers of a plurality of colors, it is preferable to employ a tandem method in which an electrostatic latent image support is used for each color.

### (Printing Substrate)

There are no particular limitations on the printing substrate onto which the printing is performed using the developer, and examples include typically used high-quality papers, coated papers, PET sheets, and PP sheets and the like. The coated papers include all of the extensive range of coated papers used in all manner of conventional applications, and specific examples include finely coated papers, coated papers, art papers, matte coated papers and cast coated papers, and there are no limitations on the thickness or shape of these papers. The surfaces of these printing substrates may be either smooth or rough, and may be transparent, semi-transparent or opaque. Further, substrates in which two or more types of these printing substrates have been bonded together may also be used. Moreover, a releasable adhesive layer or the like may be provided on the opposite side to the printing surface, or an adhesive layer or the like may be provided on the printed surface following printing.

### (Printed Material)

The printed material that represents an embodiment of the present invention is printed material obtained using the liquid developer of the embodiment described above. The printed material has at least a printing substrate and an image such as text or a pattern printed onto the printing substrate using the liquid developer of the above embodiment. There are no particular limitations on the printed material that is printed using the liquid developer, and the printed material can be used for typical commercial applications, paper packaging, packaging films, seals, or label applications or the like. Examples of the typical commercial applications include publications or documents such as catalogs or magazines which use high-quality paper or coated paper or the like, examples of the paper packaging include packaging containers and boxes which use coated paper or cardboard or the like, whereas examples of the packaging films include flexible packaging containers which use a PET sheet or PP sheet or the like.

### (Coating Treatment)

The printed material according to an embodiment of the present invention may, if necessary, be subjected to a coating treatment of the printed surface. Specific examples of this coating treatment include coating or printing of a coating composition, and lamination using a dry lamination method, solvent-free lamination method, extrusion lamination method or hot melt lamination method, and either of these techniques may be selected, or a combination of both may be used.

### EXAMPLES

The present invention is described below in further detail using a series of examples, but the aspects of the present invention are not limited by these examples. In the following description, unless specifically stated otherwise, the units “parts” all indicate “parts by mass”, and unless specifically stated otherwise, “%” always indicates “% by mass”.

The materials listed below were used in the examples.

### Synthesis Example for Binder Resin 1

A flask fitted with a reflux condenser, a distillation column, a nitrogen gas inlet, a thermometer and a stirrer was charged with the polyhydric alcohols and polybasic acids shown in Table 1, and 2 parts of dibutyltin oxide as a catalyst, nitrogen gas was introduced while the contents were stirred, and the contents were then heated to 200° C. and reacted for 4 hours while this reaction system temperature was maintained. The contents were then reacted for a further one hour under reduced pressure. The reaction system was then returned to normal pressure, the temperature of the reaction system was reduced to 100° C. or lower, and the polycondensation was halted, thus obtaining a polyester resin as the binder resin 1.

TABLE 1

| Composition | Binder Resin 1 |
|---|---|
| Bisphenol A propylene oxide adduct | 400 parts |
| Bisphenol A ethylene oxide adduct | 200 parts |
| Terephthalic acid | 270 parts |
| Trimellitic acid | 50 parts |

Within the composition recorded in Table 1, the bisphenol A propylene oxide adduct is a compound of general formula (3) wherein R represents a propylene group, and x=y=2. Further, the bisphenol A ethylene oxide adduct is a compound of general formula (3) wherein R represents an ethylene group, and x=y=2.

### Synthesis Example for Binder Resin 2

The binder resin 1 obtained above was added to an equal amount of toluene and dissolved by heating. The solution was stirred while nitrogen gas was introduced, and following heating to the boiling point of toluene, a mixed solution shown in Table 2, containing styrene, the (meth)acrylic-based monomers, and di-t-butyl peroxide as a polymerization initiator, was added dropwise over a period of 2 hours for solution polymerization. Following completion of the dropwise addition, reaction was continued for a further 2 hours at the boiling point temperature of toluene, and 1 part of di-t-butyl peroxide was then added and the polymerization was halted. Subsequently, the reaction mixture was heated to 180° C. to remove the toluene, thus obtaining the binder resin 2 containing a polyester resin and a styrene-acrylic copolymer resin.

### Synthesis Example for Binder Resin 3

Toluene was placed in a flask, nitrogen gas was introduced while the toluene was stirred, and following heating to the boiling point of toluene, a mixed solution shown in Table 2, containing styrene, the (meth)acrylic-based monomers, and di-t-butyl peroxide as a polymerization initiator, was added dropwise over a period of 2 hours for solution polymerization. Following completion of the dropwise addition, reaction was continued for a further 2 hours at the boiling point temperature of toluene, and 1 part of di-t-butyl peroxide was then added and the polymerization was halted. Subsequently, the reaction mixture was heated to 180° C. to remove the toluene, thus obtaining a styrene-acrylic copolymer resin as the binder resin 3.

TABLE 2

| Composition | Binder Resin 2 | Binder Resin 3 |
|---|---|---|
| Binder resin 1 | 800 parts | |
| Styrene | 115 parts | 497 parts |
| Acrylic acid | | 30 parts |
| 2-ethylhexyl acrylate | 62 parts | |
| n-butyl acrylate | 20 parts | |
| Ethyl methacrylate | | 200 parts |
| Methoxy diethylene glycol methacrylate | | 270 parts |
| di-t-butyl peroxide | 3 parts | 3 parts |

### Synthesis Examples for Binder Resins 4 and 5

With the exception of using the raw materials, the blend amounts and the reaction conditions recorded in Table 3, synthesis was performed in the same manner as the synthesis example for the binder resin 1, thus obtaining the binder resins 4 and 5.

TABLE 3

| Composition and Reaction Conditions | Binder Resin 4 | Binder Resin 5 |
|---|---|---|
| Bisphenol A propylene oxide adduct | 290 parts | |
| Bisphenol A ethylene oxide adduct | 290 parts | |
| Propylene glycol | | 190 parts |
| Terephthalic acid | 110 parts | 575 parts |
| Fumaric acid | 170 parts | |
| Trimellitic acid | | 435 parts |
| Reaction temperature | 210° C. | 180° C. |
| Reaction time | 2 hours | 3 hours |

The physical properties of the binder resins 1 to 5 obtained above are shown in Table 4.

TABLE 4

| | | | | Weight |
|---|---|---|---|---|
| | | | | average |
| | | Glass transition | Softening | molecular |
| | Acid value | temperature | temperature | weight |
| | (mgKOH/g) | (Tg, ° C.) | (T4) | (Mw) |
| Binder resin 1 | 26 | 52 | 112° C. | 11,000 |
| Binder resin 2 | 23 | 55 | 120° C. | 12,800 |
| Binder resin 3 | 23 | 50 | 95° C. | 25,000 |
| Binder resin 4 | 6 | 48 | 82° C. | 2,200 |
| Binder resin 5 | 15 | 50 | 105° C. | 3,600 |

### (Colorants)

The compounds recorded in Table 5 were used as colorants.

TABLE 5

| Color | C.I. Number/pigment type | Product name | Manufacturer |
|---|---|---|---|
| Cyan | Pigment Blue 15:3 | Lionol Blue FG 7919 | Toyocolor Co., Ltd. |
| | (copper phthalocyanine blue) | | |
| Magenta | Pigment Red 122 | Hostaperm Pink E | Clariant Ltd. |
| | (quinacridone magenta) | | |
| | Pigment Red 57:1 | Permanent Rubine L6B | Clariant Ltd. |
| | (carmine 6B) | | |
| Yellow | Pigment Yellow 180 | Novoperm Yellow P-HG | Clariant Ltd. |
| | (benzimidazolone yellow) | | |
| Black | Carbon black | NIPEX 150 | Degussa AG |
| White | Titanium oxide | TIPAQUE PF-740 | Ishihara Sangyo Kaisha, Ltd. |

### (Release Agents)

The compounds recorded in Table 6 were used as release agents.

TABLE 6

| Product name | Manufacturer | Wax type | Melting point |
|---|---|---|---|
| Paraffin Wax HNP-9 | Nippon Seiro Co., | paraffin | 75° C. |
| | Ltd. | | |
| Nissan Electol WEP-5 | NOF Corporation | fatty acid | 82° C. |
| | | ester | |
| Polywax 500 | TOYO ADL | unmodified | 88° C. |
| | Corporation | polyethylene | |
| Polywax 2080P | TOYO ADL | unmodified | 126° C. |
| | Corporation | polyethylene | |

### (Compound Represented by General Formula (1))

For the compound represented by general formula (1), the commercially available products recorded in Table 7 were used, and compounds 1 to 4 synthesized using the methods described below were also used.

### Production Example for Synthetic Compound 1

First, 350 parts of CH₃(CH₂)₈₉OH and 650 parts of ethylene oxide were reacted in the presence of sodium ethoxide under conditions including a pressure of 2.0×10⁵ Pa and a temperature of 150° C. After a reaction time of 30 minutes, the etherified compound that represented the reaction product was extracted. This reaction product was used as the synthetic compound 1.

### Production Example for Synthetic Compound 2

First, 80 parts of CH₃(CH₂)₂₉OH and 920 parts of ethylene oxide were reacted in the presence of sodium ethoxide under conditions including a pressure of 2.0×10⁵ Pa and a temperature of 150° C. After a reaction time of 30 minutes, the etherified compound that represented the reaction product was extracted. This reaction product was used as the synthetic compound 2.

### Production Example for Synthetic Compound 3

First, 80 parts of isostearyl alcohol and 920 parts of ethylene oxide were reacted in the presence of sodium ethoxide under conditions including a pressure of 2.0×10⁵ Pa and a temperature of 150° C. After a reaction time of 30 minutes, the etherified compound that represented the reaction product was extracted. This reaction product was used as the synthetic compound 3.

### Production Example for Synthetic Compound 4

First, 70 parts of CH₃(CH₂)₂₉OH and 930 parts of ethylene oxide were reacted in the presence of sodium ethoxide under conditions including a pressure of 2.0×10⁵ Pa and a temperature of 150° C. After a reaction time of 30 minutes, the etherified compound that represented the reaction product was extracted. This reaction product was used as the synthetic compound 4.

TABLE 7

| | Product name | | R1 | | | | |
|---|---|---|---|---|---|---|---|
| | Synthetic | | | Carbon atom | A1 | | |
| | compound name | Manufacturer | Structure | number | Structure | n | HLB |
| Commercially | UNITHOX 520 | TOYO ADL | linear | 37 | ethylene | 3 to 4 | 4 |
| available | | Corporation | aliphatic | | | | |
| products | UNITHOX 450 | TOYO ADL | hydrocarbon | 32 | ethylene | 10 | 10 |
| | | Corporation | | | | | |
| | UNITHOX 490 | TOYO ADL | | 30 | ethylene | 94 | 18 |
| | | Corporation | | | | | |
| | UNITHOX 750 | TOYO ADL | | 49 | ethylene | 16 | 10 |
| | | Corporation | | | | | |
| | EMULGEN 320P | Kao | | 18 | ethylene | 13 | 14 |
| | | Corporation | | | | | |
| | EMALEX | Nihon Emulsion | | 10 | ethylene - | 17 | 13 |
| | DAPE 0215 | Co., Ltd. | | | propylene | | |
| | EMALEX BHA-20 | Nihon Emulsion | | 22 | ethylene | 20 | 12 |
| | | Co., Ltd. | | | | | |
| | NP-2 | Nikko Chemicals | aromatic | 15 | ethylene | 2 | 6 |
| | | Co., Ltd. | hydrocarbon | | | | |
| Synthetic | Synthetic compound 1 | — | aliphatic | 90 | ethylene | 54 | 11 |
| Compounds | Synthetic compound 2 | | hydrocarbon | 30 | ethylene | 110 | 18 |
| | Synthetic compound 3 | | (1, 2 and 4: | 18 | ethylene | 67 | 18 |
| | Synthetic compound 4 | | linear, | 30 | ethylene | 128 | 18 |
| | | | 3: branched | | | | |

### (Dispersant)

Antaron V-216 (manufactured by ISP Chemicals, Inc., hereafter abbreviated as V-216) was used as the dispersant.

### (Carrier Liquid)

Exxsol D130 (a naphthene-based hydrocarbon manufactured by Exxon Mobil Corporation, aniline point: 88° C., dry point: 313° C.) was used as the carrier liquid.

(Preparation of Liquid Developer 1C)

| | | |
|---|---|---|
| C.I. Pigment Blue 15:3 (Lionol Blue FG7919) | 18 | parts by mass |
| Binder resin 1 | 78.8 | parts by mass |
| Paraffin wax HNP-9 | 3 | parts by mass |
| UNITHOX 520 | 0.2 | parts by mass |

The above materials (total: 5 kg) were mixed (at 3,000 rpm for 3 minutes) in a Henschel mixer having a capacity of 20 L, were subsequently subjected to melt kneading in a twin-screw kneading extruder (PCM30) under conditions including a supply rate of 6 kg/hr and a discharge temperature of 145° C., and were then further kneaded using a triple roll mill at a roll temperature of 140° C. Following cooling and solidification, the solid product was coarsely ground using a hammer mill, and was then finely ground using an I-type jet mill (model: IDS-2) to obtain a cyan ground product 1 having an average particle size of 5.0 μm.

| | |
|---|---|
| Cyan ground product 1 | 25 parts by mass |
| Exxsol D130 | 74 parts by mass |
| Antaron V-216 | 1 part by mass |

The above materials were weighed, and then stirred and mixed thoroughly, thereby dispersing the cyan ground product 1 in a solution of the Exxsol D130 (slurry concentration: 25% by mass). Using a Dyno-Mill Multilab (manufactured by Shinmaru Enterprises Corporation, capacity: 1.4 L), which is a medium stirring mill, the slurry containing the dispersed cyan ground product 1 was subjected to wet grinding under circulatory operating conditions for 60 minutes. The conditions for the wet grinding were as follows. Agitator discs (material: zirconia), peripheral speed: 10 m/s, cylinder: ZTA, media (material: zirconia) diameter: 1.25 mm, fill rate: 70%, solution flow rate: 45 kg/h, cooling water: 5 L/min, pressure: 0.1 kg/cm². After performing wet grinding for 60 minutes, the slurry was removed and passed through a mesh (made of SUS304) having a mesh size of 33 μm, thus obtaining a liquid developer 1C (containing cyan toner particles 1). Investigation of the particle size distribution of the cyan toner particles 1 revealed an average particle size (D50) of 2.5 μm. The viscosity (η) of the liquid developer 1C was 50 mPa·s.

The particle size was measured using a laser diffraction/scattering particle size analyzer Microtrac HRA manufactured by Nikkiso Co., Ltd., using Exxsol™ D80 (manufactured by Exxon Mobil Corporation) as the solvent, and under atmospheric conditions of 23° C. and 50% RH. The viscosity (η) was measured using an E-type viscometer TV-22 manufactured by Toki Sangyo Co., Ltd. Specifically, the solid fraction within the liquid developer was adjusted to 25%, and following thorough blending at 25° C., a 1° 34′ cone was installed in the TV-22 viscometer, and the viscosity was measured after agitation at 10 rpm for one minute.

### (Preparation of Other Liquid Developers)

Using the raw materials shown in Tables 8 to 10, the same method as that described for the cyan ground product 1 was used to produce toner ground products. Subsequently, the toner ground products, the dispersant and the carrier liquid shown in Table 11 were used to prepare liquid developers using the same method as that described for the liquid developer 1C.

TABLE 8

| | | Cyan | | | | | | |
|---|---|---|---|---|---|---|---|---|
| | | Ground | Ground | Ground | Ground | Ground | Ground | Ground |
| | | product | product | product | product | product | product | product |
| Composition | | 1 | 2 | 3 | 4 | 5 | 6 | 7 |
| Binder | Binder resin 1 | 78.8 | 78.8 | 78.8 | 78.8 | 78.8 | 78.8 | 78.8 |
| resin (A) | | | | | | | | |
| Release | Paraffin wax | 3 | 3 | 3 | 3 | 3 | 3 | 3 |
| agent (B) | HNP-9 | | | | | | | |
| | Nissan Electol | | | | | | | |
| | WEP-5 | | | | | | | |
| | Polywax 500 | | | | | | | |
| | Polywax 2080P | | | | | | | |
| Compound | UNITHOX 520 | 0.2 | | | | | | |
| represented | UNITHOX 450 | | 0.2 | | | | | |
| by general | UNITHOX 490 | | | 0.2 | | | | |
| formula (1) | UNITHOX 750 | | | | 0.2 | | | |
| | EMULGEN 320P | | | | | 0.2 | | |
| | EMALEX | | | | | | 0.2 | |
| | DAPE-0215 | | | | | | | |
| | EMALEX BHA-20 | | | | | | | 0.2 |
| | NP-2 | | | | | | | |
| | Synthetic | | | | | | | |
| | compound 1 | | | | | | | |
| | Synthetic | | | | | | | |
| | compound 2 | | | | | | | |
| | Synthetic | | | | | | | |
| | compound 3 | | | | | | | |
| Colorant | C.I. Pigment | 18 | 18 | 18 | 18 | 18 | 18 | 18 |
| | Blue 15:3 | | | | | | | |
| | | Cyan | | | | | | |
| | | Ground | Ground | Ground | Ground | Ground | Ground | Ground |
| | | product | product | product | product | product | product | product |
| Composition | | 8 | 9 | 10 | 11 | 12 | 13 | 14 |
| Binder | Binder resin 1 | 78.8 | 78.8 | 78.8 | 78.8 | 78.8 | 78.8 | 78.8 |
| resin (A) | | | | | | | | |
| Release | Paraffin wax | 3 | 3 | 3 | 3 | | | |
| agent (B) | HNP-9 | | | | | | | |
| | Nissan Electol | | | | | 3 | | |
| | WEP-5 | | | | | | | |
| | Polywax 500 | | | | | | 3 | |
| | Polywax 2080P | | | | | | | 3 |
| Compound | UNITHOX 520 | | | | | | | |
| represented | UNITHOX 450 | | | | | | | |
| by general | UNITHOX 490 | | | | | 0.2 | 0.2 | 0.2 |
| formula (1) | UNITHOX 750 | | | | | | | |
| | EMULGEN 320P | | | | | | | |
| | EMALEX | | | | | | | |
| | DAPE-0215 | | | | | | | |
| | EMALEX BHA-20 | | | | | | | |
| | NP-2 | 0.2 | | | | | | |
| | Synthetic | | 0.2 | | | | | |
| | compound 1 | | | | | | | |
| | Synthetic | | | 0.2 | | | | |
| | compound 2 | | | | | | | |
| | Synthetic | | | | 0.2 | | | |
| | compound 3 | | | | | | | |
| Colorant | C.I. Pigment | 18 | 18 | 18 | 18 | 18 | 18 | 18 |
| | Blue 15:3 | | | | | | | |

Units: parts by mass

TABLE 9

| | | Cyan | | | | | | | |
|---|---|---|---|---|---|---|---|---|---|
| | | Ground | Ground | Ground | Ground | Ground | Ground | Ground | Ground |
| | | product | product | product | product | product | product | product | product |
| Composition | | 15 | 16 | 17 | 18 | 19 | 20 | 21 | 22 |
| Binder | Binder resin 1 | 78.4 | 78.9 | 78 | 77 | | | | |
| resin (A) | Binder resin 2 | | | | | 78.8 | | | |
| | Binder resin 3 | | | | | | 78.8 | | |
| | Binder resin 4 | | | | | | | 78.8 | |
| | Binder resin 5 | | | | | | | | 78.8 |
| Release | Paraffin wax | | | | | 3 | 3 | 3 | 3 |
| agent (B) | HNP-9 | | | | | | | | |
| | Nissan Electol | | | | | | | | |
| | WEP-5 | | | | | | | | |
| | Polywax 500 | | | | | | | | |
| | Polywax 2080P | 3 | 3 | 3 | 3 | | | | |
| Compound | UNITHOX 490 | 0.6 | 0.1 | 1 | 2 | 0.2 | 0.2 | 0.2 | 0.2 |
| represented | Synthetic | | | | | | | | |
| by general | compound 4 | | | | | | | | |
| formula (1) | | | | | | | | | |
| Colorant | C.I. Pigment | 18 | 18 | 18 | 18 | 18 | 18 | 18 | 18 |
| | Blue 15:3 | | | | | | | | |

| | | Cyan | | | | | |
|---|---|---|---|---|---|---|---|
| | | Compar- | Compar- | Compar- | Compar- | Compar- | Compar- |
| | | ative | ative | ative | ative | ative | ative |
| | | ground | ground | ground | ground | ground | ground |
| | | product | product | product | product | product | product |
| Composition | | 1 | 2 | 3 | 4 | 5 | 6 |
| Binder | Binder resin 1 | 79 | 79 | 79 | 79 | 81.8 | 78.8 |
| resin (A) | Binder resin 2 | | | | | | |
| | Binder resin 3 | | | | | | |
| | Binder resin 4 | | | | | | |
| | Binder resin 5 | | | | | | |
| Release | Paraffin wax | 3 | | | | | 3 |
| agent (B) | HNP-9 | | | | | | |
| | Nissan Electol | | 3 | | | | |
| | WEP-5 | | | | | | |
| | Polywax 500 | | | 3 | | | |
| | Polywax 2080P | | | | 3 | | |
| Compound | UNITHOX 490 | | | | | 0.2 | |
| represented | Synthetic | | | | | | 0.2 |
| by general | compound 4 | | | | | | |
| formula (1) | | | | | | | |
| Colorant | C.I. Pigment | 18 | 18 | 18 | 18 | 18 | 18 |
| | Blue 15:3 | | | | | | |

Units: parts by mass

TABLE 10

| | | | | | | Yellow | Magenta | Black | White |
|---|---|---|---|---|---|---|---|---|---|
| | | Yellow | Magenta | Black | White | Comparative | Comparative | Comparative | Comparative |
| | | Ground | Ground | Ground | Ground | ground | ground | ground | ground |
| Composition | | product | product | product | product | product | product | product | product |
| Binder | Binder resin 1 | 79 | 77 | 76 | 66.8 | 79 | 77 | 76 | 66.8 |
| resin (A) | Binder resin 2 | | | | | | | | |
| | Binder resin 3 | | | | | | | | |
| | Binder resin 4 | | | | | | | | |
| | Binder resin 5 | | | | | | | | |
| Release agent (B) | Paraffin wax HNP-9 | 3 | 3 | 3 | 3 | 3 | 3 | 3 | 3 |
| Compound | UNITHOX 490 | 0.2 | 0.2 | 0.2 | 0.2 | | | | |
| represented | | | | | | | | | |
| by general | | | | | | | | | |
| formula (1) | | | | | | | | | |
| Colorant | C.I. Pigment | | | 1 | | | | 1 | |
| | Blue 15:3 | | | | | | | | |
| | C.I. Pigment | 18 | | | | 18 | | | |
| | Yellow 180 | | | | | | | | |
| | C.I. Pigment | | 10 | | | | 10 | | |
| | Red 122 | | | | | | | | |
| | C.I. Pigment | | 10 | | | | 10 | | |
| | Red 57:1 | | | | | | | | |
| | Carbon black | | | 20 | | | | 20 | |
| | Titanium oxide | | | | 30 | | | | 30 |

Units: parts by mass

TABLE 11

| | | | parts | | parts | | parts |
|---|---|---|---|---|---|---|---|
| | | | by | | by | Carrier | by |
| | | Toner ground product | mass | Dispersant | mass | liquid | mass |
| Example 1 | Liquid developer 1C | Cyan ground product 1 | 25 | V-216 | 1 | Exxsol D130 | 74 |
| Example 2 | Liquid developer 2C | Cyan ground product 2 | 25 | V-216 | 1 | Exxsol D130 | 74 |
| Example 3 | Liquid developer 3C | Cyan ground product 3 | 25 | V-216 | 1 | Exxsol D130 | 74 |
| Example 4 | Liquid developer 4C | Cyan ground product 4 | 25 | V-216 | 1 | Exxsol D130 | 74 |
| Example 5 | Liquid developer 5C | Cyan ground product 5 | 25 | V-216 | 1 | Exxsol D130 | 74 |
| Example 6 | Liquid developer 6C | Cyan ground product 6 | 25 | V-216 | 1 | Exxsol D130 | 74 |
| Example 7 | Liquid developer 7C | Cyan ground product 7 | 25 | V-216 | 1 | Exxsol D130 | 74 |
| Example 8 | Liquid developer 8C | Cyan ground product 8 | 25 | V-216 | 1 | Exxsol D130 | 74 |
| Example 9 | Liquid developer 9C | Cyan ground product 9 | 25 | V-216 | 1 | Exxsol D130 | 74 |
| Example 10 | Liquid developer 10C | Cyan ground product 10 | 25 | V-216 | 1 | Exxsol D130 | 74 |
| Example 11 | Liquid developer 11C | Cyan ground product 11 | 25 | V-216 | 1 | Exxsol D130 | 74 |
| Example 12 | Liquid developer 12C | Cyan ground product 12 | 25 | V-216 | 1 | Exxsol D130 | 74 |
| Example 13 | Liquid developer 13C | Cyan ground product 13 | 25 | V-216 | 1 | Exxsol D130 | 74 |
| Example 14 | Liquid developer 14C | Cyan ground product 14 | 25 | V-216 | 1 | Exxsol D130 | 74 |
| Example 15 | Liquid developer 15C | Cyan ground product 15 | 25 | V-216 | 1 | Exxsol D130 | 74 |
| Example 16 | Liquid developer 16C | Cyan ground product 16 | 25 | V-216 | 1 | Exxsol D130 | 74 |
| Example 17 | Liquid developer 17C | Cyan ground product 17 | 25 | V-216 | 1 | Exxsol D130 | 74 |
| Example 18 | Liquid developer 18C | Cyan ground product 18 | 25 | V-216 | 1 | Exxsol D130 | 74 |
| Example 19 | Liquid developer 19C | Cyan ground product 19 | 25 | V-216 | 1 | Exxsol D130 | 74 |
| Example 20 | Liquid developer 20C | Cyan ground product 20 | 25 | V-216 | 1 | Exxsol D130 | 74 |
| Example 21 | Liquid developer 21C | Cyan ground product 21 | 25 | V-216 | 1 | Exxsol D130 | 74 |
| Example 22 | Liquid developer 22C | Cyan ground product 22 | 25 | V-216 | 1 | Exxsol D130 | 74 |
| Example 23 | Liquid developer 21Y | Yellow ground product | 25 | V-216 | 1 | Exxsol D130 | 74 |
| Example 24 | Liquid developer 22M | Magenta ground product | 25 | V-216 | 1 | Exxsol D130 | 74 |
| Example 25 | Liquid developer 23K | Black ground product | 25 | V-216 | 1 | Exxsol D130 | 74 |
| Example 26 | Liquid developer 24W | White ground product | 25 | V-216 | 1 | Exxsol D130 | 74 |
| Comparative | Liquid developer 31C | Cyan comparative | 25 | V-216 | 1 | Exxsol D130 | 74 |
| Example 1 | | ground product 1 | | | | | |
| Comparative | Liquid developer 32C | Cyan comparative | 25 | V-216 | 1 | Exxsol D130 | 74 |
| Example 2 | | ground product 2 | | | | | |
| Comparative | Liquid developer 33C | Cyan comparative | 25 | V-216 | 1 | Exxsol D130 | 74 |
| Example 3 | | ground product 3 | | | | | |
| Comparative | Liquid developer 34C | Cyan comparative | 25 | V-216 | 1 | Exxsol D130 | 74 |
| Example 4 | | ground product 4 | | | | | |
| Comparative | Liquid developer 35C | Cyan comparative | 25 | V-216 | 1 | Exxsol D130 | 74 |
| Example 5 | | ground product 5 | | | | | |
| Comparative | Liquid developer 36C | Cyan comparative | 25 | V-216 | 1 | Exxsol D130 | 74 |
| Example 6 | | ground product 6 | | | | | |
| Comparative | Liquid developer 37Y | Yellow comparative | 25 | V-216 | 1 | Exxsol D130 | 74 |
| Example 7 | | ground product | | | | | |
| Comparative | Liquid developer 38M | Magenta comparative | 25 | V-216 | 1 | Exxsol D130 | 74 |
| Example 8 | | ground product | | | | | |
| Comparative | Liquid developer 39K | Black comparative | 25 | V-216 | 1 | Exxsol D130 | 74 |
| Example 9 | | ground product | | | | | |
| Comparative | Liquid developer 40W | White comparative | 25 | V-216 | 1 | Exxsol D130 | 74 |
| Example 10 | | ground nroduct | | | | | |

For the toner particles contained in the liquid developers 1C to 11C and the liquid developer 31C, the liquid developer 12C and the liquid developer 32C, the liquid developer 13C and the liquid developer 33C, and the liquid developers 14C to 18C and the liquid developer 34C, the method described above using a transmission electron microscope was used to compare the domain size of the release agent (B). The results revealed that in the toner particles contained in the liquid developers 1C to 18C, the domain size of the release agent (B) had been reduced. These results indicate that the compounds represented by general formula (1) used in the toner particles contained in the liquid developers 1C to 18C were functioning as a compatibilizer for the binder resin (A) and the release agent (B).

Further, in a similar manner, the toner particles contained in the liquid developers 19C to 22C, which were produced by replacing the compound represented by general formula (1) with the various binder resins (A), were inspected using the transmission electron microscope method described above to compare the domain size of the release agent (B). The results revealed that in the toner particles contained in the liquid developers 19C to 22C, the domain size of the release agent (B) had been reduced. These results indicate that the compound represented by general formula (1) used in the toner particles contained in the liquid developers 19C to 22C was functioning as a compatibilizer for the binder resin (A) and the release agent (B).

Moreover, for the liquid developers 1C to 22C, the method described above using a high performance liquid chromatograph-mass spectrometer was used to measure the proportion of the compound represented by general formula (1) contained within the interior of the toner particles in each of the liquid developers. The results revealed that in each of the liquid developers, at least 50% by mass of the total amount of the compound represented by general formula (1) contained in the liquid developer existed within the interior of the toner particles. These results indicate that the compounds represented by general formula (1) used in the liquid developers 1C to 22C existed mainly within the interior of the toner particles.

### Examples 1 to 26, Comparative Examples 1 to 10

For each of the liquid developers shown in Table 11, the following evaluations were performed. The evaluation results are shown in Table 12, together with details relating to the physical property values for each liquid developer.

### (Actual Copy Test)

An actual copy test was performed using a modified version of a commercially available liquid developer copier (Savin 870, manufactured by Savin Corporation). Specifically, 1,000 copies were printed continuously under atmospheric conditions of 23° C. and 50% RH using an amorphous silicon photoreceptor, with the photoreceptor surface potential set to +450 to 500 V, the residual potential set to not more than +50 V, and the developing roller bias set to +250 to 450 V. Evaluations of the image density and the fixing ratio described below were performed using the 1,000th image, whereas evaluations of the cold offset resistance and the hot offset resistance were performed using those images from the 951st image onward. Single-color printing was performed using each color, and in the evaluation of the color toners, OK Topcoat+paper manufactured by Oji Paper Co., Ltd. was used as the substrate, and the thermocompression bonding was performed under conditions including a speed of 30 m/min and a temperature of 160° C. In the evaluation of the white toner, a PET film was used as the substrate, and the thermocompression bonding was performed under conditions including a speed of 30 m/min and a temperature of 120° C.

### (Image Density)

The image density of a solid image portion was measured using a spectral densitometer X-Rite 504 (manufactured by S.D.G K.K.) under conditions including a D50 light source, a viewing angle of 2°, and the Status-E condition. Density values of 1.2 or greater for yellow, 1.4 or greater for magenta and cyan, and 1.6 or greater for black are preferred from a practical perspective. More preferred values are 1.3 or greater for yellow, 1.5 or greater for magenta and cyan, and 1.7 or greater for black. For cyan, a value of 1.6 or greater is particularly preferred.

### (Hiding Power Evaluation)

For Example 26 and Comparative Example 10, a hiding power evaluation was performed instead of the above image density evaluation. Specifically, white single-color image output was performed at a toner particle concentration of 25%, the resulting solid image was overlaid on a paper substrate having a black single-color image with a density of 1.80, a spectral densitometer X-Rite 504 (manufactured by S.D.G K.K.) was used to measure the black image density under conditions including a D50 light source, a viewing angle of 2° and the Status-E condition, and the hiding power was evaluated based on the degree of reduction in the black density. The evaluation criteria were as follows, with an A level being preferred from a practical perspective.

A: black ID value of less than 0.25

B: black ID value of 0.25 or greater

### (Fixing Ratio)

Using a printed image that was output with a 1 cm×1 cm solid-printed portion, the image density ID (ID1) at the time of output was measured using the same method as that described above for the image density. Subsequently, a mending tape (Scotch (a registered trademark) 810, manufactured by 3M Corporation) was adhered to the printed image, and a 1 kg circular cylindrical brass weight was rolled once back and forth across the image. Subsequently, the mending tape was removed, and the image density ID (ID2) was remeasured. The fixing ratio (%) was determined from the obtained results by calculating the value of (ID2)/(ID1)×100. A fixing ratio of 80% or greater is preferable from a practical perspective, and a fixing ratio of 90% or greater is particularly preferred.

### (Cold Offset Resistance)

Ten output images that had been output using the apparatus described above were consecutively subjected to thermocompression bonding using an external fixing unit under conditions including a speed of 30 m/min and a nip thickness of 6 mm, and upon thennocompression bonding of the 10th outputted image, a determination was made as to whether a retransferred toner image existed on the 10th outputted image (paper). The temperature at which a retransferred toner image no longer existed was evaluated using the 4-stage ranking shown below. An evaluation of B or better is preferred from a practical perspective, and an evaluation of A is particularly preferred.

A: thermocompression bonding roller temperature of less than 120° C.

B: thermocompression bonding roller temperature of at least 120° C. but less than 140° C.

C: thennocompression bonding roller temperature of at least 140° C. but less than 160° C.

D: thennocompression bonding roller temperature of 160° C. or higher

### (Hot Offset Resistance)

An image that had been output using the apparatus described above was subjected to thennocompression bonding using an external fixing unit under conditions including a speed of 15 m/min and a nip thickness of 6 mm, and the temperature at which toner particles started to adhere to the surface of the roller used for this thermocompression bonding was evaluated using the 4-stage ranking shown below. An evaluation of B or better is preferred from a practical perspective, and an evaluation of A is particularly preferred.

A: thermocompression bonding roller temperature of 160° C. or higher

B: thermocompression bonding roller temperature of at least 140° C. but less than 160° C.

C: thermocompression bonding roller temperature of at least 120° C. but less than 140° C.

D: thermocompression bonding roller temperature of at least 120° C.

### (Storage Stability)

Each prepared liquid developer was left to stand for 3 months in a constant-temperature and constant-humidity atmosphere at 25° C. and 50% RH. After standing for 3 months, the average particle size (D50) and the viscosity (η) of the liquid developer were remeasured using the methods described above, and the storage stability was evaluated by determining the increase in the measured values from the values prior to starting the test. The evaluation criteria were as follows.

(Average particle size (D50))

A: Average particle size (D50) after test/average particle size (D50) before test is less than 1.1

B: Average particle size (D50) after test/average particle size (D50) before test is at least 1.1 but less than 1.2

C: Average particle size (D50) after test/average particle size (D50) before test is 1.2 or greater

A ranking of B or better is preferred from a practical perspective, and a ranking of A is particularly preferred.

### (Viscosity (η)

A: Viscosity (η) after test/viscosity (η) before test is less than 1.1

B: Viscosity (η) after test/viscosity (η) before test is at least 1.1 but less than 1.4

C: Viscosity (η) after test/viscosity (η) before test is 1.4 or greater

A ranking of B or better is preferred from a practical perspective, and a ranking of A is particularly preferred.

TABLE 12

| | Particle | Viscosity | | | Fixing | | | Storage stability | |
|---|---|---|---|---|---|---|---|---|---|
| | size D50 | η | Image | Hiding | ratio | Cold offset | Hot offset | Particle | Viscosity |
| | (μm) | (mPa · s) | density | power | (%) | resistance | resistance | size D50 | η |
| Example 1 | 2.5 | 50 | 1.48 | — | 80 | B | B | B | B |
| Example 2 | 2.5 | 48 | 1.62 | — | 88 | A | B | A | A |
| Example 3 | 2.2 | 53 | 1.60 | — | 92 | A | B | A | A |
| Example 4 | 2.5 | 48 | 1.60 | — | 88 | A | B | A | A |
| Example 5 | 2.2 | 48 | 1.56 | — | 90 | B | B | B | B |
| Example 6 | 2.4 | 55 | 1.51 | — | 81 | B | B | B | B |
| Example 7 | 2.5 | 52 | 1.50 | — | 82 | A | B | B | B |
| Example 8 | 2.6 | 49 | 1.49 | — | 80 | B | B | B | B |
| Example 9 | 2.3 | 62 | 1.60 | — | 86 | A | B | B | A |
| Example 10 | 2.2 | 60 | 1.63 | — | 82 | A | B | A | B |
| Example 11 | 2.5 | 53 | 1.61 | — | 91 | B | B | B | B |
| Example 12 | 2.9 | 60 | 1.48 | — | 80 | B | B | B | B |
| Example 13 | 2.4 | 50 | 1.60 | — | 84 | A | B | A | B |
| Example 14 | 2.8 | 45 | 1.68 | — | 94 | A | A | A | A |
| Example 15 | 2.6 | 46 | 1.65 | — | 92 | A | A | A | A |
| Example 16 | 2.8 | 45 | 1.55 | — | 84 | B | A | B | B |
| Example 17 | 2.6 | 46 | 1.65 | — | 92 | A | A | B | B |
| Example 18 | 2.4 | 54 | 1.67 | — | 90 | A | B | B | B |
| Example 19 | 2.4 | 54 | 1.67 | — | 90 | A | A | A | A |
| Example 20 | 2.8 | 46 | 1.55 | — | 89 | B | B | A | B |
| Example 21 | 2.6 | 41 | 1.63 | — | 88 | A | A | A | A |
| Example 22 | 2.7 | 58 | 1.58 | — | 80 | A | B | A | B |
| Example 23 | 2.4 | 55 | 1.42 | — | 93 | A | A | A | A |
| Example 24 | 2.5 | 42 | 1.57 | — | 91 | A | A | A | A |
| Example 25 | 2.2 | 32 | 1.85 | — | 90 | A | A | A | A |
| Example 26 | 2.7 | 25 | — | A | 85 | A | A | A | A |
| Comparative | 2.7 | 53 | 1.20 | — | 62 | D | B | C | C |
| Example 1 | | | | | | | | | |
| Comparative | 2.8 | 62 | 1.32 | — | 60 | D | B | C | C |
| Example 2 | | | | | | | | | |
| Comparative | 2.2 | 65 | 1.38 | — | 65 | C | B | C | B |
| Example 3 | | | | | | | | | |
| Comparative | 2.7 | 68 | 1.25 | — | 55 | C | B | C | C |
| Example 4 | | | | | | | | | |
| Comparative | 2.4 | 78 | 1.30 | — | 70 | B | D | C | C |
| Example 5 | | | | | | | | | |
| Comparative | 2.8 | 58 | 1.47 | — | 81 | C | B | C | B |
| Example 6 | | | | | | | | | |
| Comparative | 2.7 | 53 | 1.32 | — | 64 | D | B | C | C |
| Example 7 | | | | | | | | | |
| Comparative | 2.5 | 63 | 1.38 | — | 63 | D | B | C | C |
| Example 8 | | | | | | | | | |
| Comparative | 2.5 | 53 | 1.40 | — | 62 | D | B | C | C |
| Example 9 | | | | | | | | | |
| Comparative | 2.9 | 35 | — | B | 58 | D | B | C | C |
| Example 10 | | | | | | | | | |

In Comparative Examples 1 to 4 and 7 to 9, it is thought that because the compound represented by general formula (1) was not included, the compatibility between the binder resin (A) and the release agent (B) was poor, resulting in at least one of the image density, the fixing ratio and the cold offset resistance being inadequate. On the other hand, Comparative Example 5 is an example that does not contain the release agent (B), and the results for the hot offset resistance and the storage stability were poor. In particular, the result for the hot offset resistance was level D, which represents an extremely poor result, but it is thought that because the compound represented by general formula (1) was used without using the release agent (B), the compound represented by general formula (1) functioned as a plasticizer, resulting in a dramatic lowering of the softening temperature and the glass transition temperature of the toner particles. Further, Comparative Example 6 is an example in which the compound corresponding with the compound represented by general formula (1) that was used had an n value larger than 120, and it is thought that because the hydrophilicity of this compound was too strong, the compatibility between the binder resin (A) and the release agent (B) was unsatisfactory, leading to poor results for the cold offset resistance and the storage stability.

In contrast, the liquid developers of the Examples yielded results in the practically applicable region for each of the image density, the fixing ratio, the cold offset resistance, the hot offset resistance and the storage stability. Further, it was evident that among the liquid developers that used a cyan toner, Examples 14, 15, 19 and 21 yielded particularly superior results in terms of the image density, the fixing ratio and the storage stability.

### Examples 27 to 33, Comparative Examples 11 to 17

The liquid developers shown above in Table 13 were combined, and the evaluations described below were conducted. The test conditions and the results are shown in Table 13.

### (Overprinted Image Actual Copy Test)

An overprinted image actual copy test was conducted using the modified liquid developer copier described above, and with the exception of removing the heat fixing mechanism, was performed under the same potential conditions as the single-color copying. Following output of a solid image across the entire substrate surface using a liquid developer of one color, the liquid developer inside the copier was substituted with a second color, and output of a solid image of the second color was overprinted on top of the previously printed solid image. Using this method, 15 unfixed overprinted solid printed items were prepared, and these items were evaluated as follows.

### (Overprinted Cold Offset Resistance)

Ten unfixed overprinted solid printed items prepared using the method described above were consecutively subjected to thermocompression bonding using an external fixing unit under conditions including a speed of 10 m/min and a nip thickness of 6 mm, and upon thermocompression bonding of the 10th printed item, a determination was made as to whether a retransferred toner image existed on the 10th outputted image (paper). The temperature at which a retransferred toner image no longer existed was evaluated using the 4-stage ranking shown below. An evaluation of B or better is preferred from a practical perspective, and an evaluation of A is particularly preferred.

A: thermocompression bonding roller temperature of less than 120° C.

B: thermocompression bonding roller temperature of at least 120° C. but less than 140° C.

C: thermocompression bonding roller temperature of at least 140° C. but less than 160° C.

D: thermocompression bonding roller temperature of 160° C. or higher

### (Overprinted Fixing Ratio)

One of the overprinted solid printed items prepared using the method described above was subjected to thermocompression bonding using an external fixing unit under conditions including a speed of 5 in/min, a nip thickness of 6 mm, and a thermocompression roller temperature of 160° C. Using the thus obtained fixed printed item, the overprinted fixing ratio was calculated in a similar manner to that described for the fixing ratio of the single-color printed images, by comparing the image density before and after adhering a mending tape to the printed item. The image density measured was the image density value for the color image of the second color. A fixing ratio of 80% or higher is preferred from a practical perspective, and a fixing ratio of 90% or higher is particularly preferred.

TABLE 13

| | Liquid developer | | Superimposed cold | Superimposed |
|---|---|---|---|---|
| | First color | Second color | offset resistance | fixing ratio (%) |
| Example 27 | Liquid developer 24W | Liquid developer 4C | B | 83 |
| Example 28 | Liquid developer 24W | Liquid developer 21Y | B | 85 |
| Example 29 | Liquid developer 24W | Liquid developer 22M | B | 82 |
| Example 30 | Liquid developer 24W | Liquid developer 23K | B | 85 |
| Example 31 | Liquid developer 22M | Liquid developer 21Y | A | 90 |
| Example 32 | Liquid developer 4C | Liquid developer 21Y | A | 91 |
| Example 33 | Liquid developer 4C | Liquid developer 22M | A | 88 |
| Comparative | Liquid developer 24W | Liquid developer 36C | D | 55 |
| Example 11 | | | | |
| Comparative | Liquid developer 24W | Liquid developer 37Y | D | 43 |
| Example 12 | | | | |
| Comparative | Liquid developer 24W | Liquid developer 38M | D | 48 |
| Example 13 | | | | |
| Comparative | Liquid developer 24W | Liquid developer 39K | D | 46 |
| Example 14 | | | | |
| Comparative | Liquid developer 22M | Liquid developer 37Y | D | 55 |
| Example 15 | | | | |
| Comparative | Liquid developer 4C | Liquid developer 37Y | D | 53 |
| Example 16 | | | | |
| Comparative | Liquid developer 4C | Liquid developer 38M | D | 58 |
| Example 17 | | | | |

In Examples 27 to 33, the overprinted cold offset resistance and the overprinted fixing ratio were both within the practically applicable regions. In contrast, in Comparative Examples 11 to 17, in which even though a liquid developer containing a compound represented by general formula (1) was used as the first color, a liquid developer that did not contain a compound represented by general formula (1) was used for the second color, neither the overprinted cold offset resistance nor the overprinted fixing ratio reached a practically applicable level.

### INDUSTRIAL APPLICABILITY

The liquid developer according to an embodiment of the present invention exhibits excellent color development properties, storage stability, fixability and cold offset resistance, and can be used for developing an electrostatic latent image in an electronic copier, printer, or on-demand printing device or the like in which images are formed using an electrophotographic method or an electrostatic recording method.

1. A liquid developer comprising at least toner particles containing a binder resin (A) and a release agent (B), and a carrier liquid (C), wherein
the toner particles also contain a compound represented by general formula (1) shown below:
R1-(O-A1)ₙ—OH General formula (1):
wherein n represents a natural number from 1 to 120, R1 represents a hydrocarbon group of 1 to 100 carbon atoms, and A1 represents an alkylene group of 2 to 4 carbon atoms.

2. The liquid developer according to claim 1, wherein n is a natural number from 10 to 100.

3. The liquid developer according to claim 1, wherein Al is an ethylene group.

4. The liquid developer according to claim 1, wherein R1 is an aliphatic hydrocarbon group of 20 to 100 carbon atoms.

5. The liquid developer according to claim 1, wherein an HLB value of the compound represented by the general formula (1), measured using Griffin's method, is at least 10 but not more than 20.

6. The liquid developer according to claim 1, wherein the release agent (B) has a structure represented by R1 in the general formula (1).

7. The liquid developer according to claim 1, wherein the release agent (B) is a hydrocarbon-based wax.

8. The liquid developer according to claim 1, wherein the binder resin (A) has a structure represented by general formula (2) shown below:
—(O-A2)ₘ- General formula (2):
wherein m represents a natural number from 1 to 10, and A2 represents an alkylene group of 2 to 4 carbon atoms.

9. A method for producing the liquid developer according to claim 1, the method comprising a step of melt kneading a mixture containing the binder resin (A), the release agent (B), and the compound represented by the general formula (1).

10. A method for producing printed material, the method comprising a step of performing printing using the liquid developer according to claim 1.
